(19) United States
(12) Patent Application Publication
(10) Pub. No.: US 2014/0030623 A1
(43) Pub. Date: Jan. 30, 2014

(54) SEMI-SOLID FILLED BATTERY AND METHOD OF MANUFACTURE

(71) Applicant: 24M Technologies, Inc., Cambridge, MA (US)

(72) Inventors: Yet-Ming Chiang, Framingham, MA (US); William Craig Carter, Jamaica Plain, MA (US); Pimpa Limthongkul, Boston, MA (US); Ricardo Bazzarella, Woburn, MA (US); Mihai Duduta, Somerville, MA (US); Jeffry Disko, North Brookfield, MA (US); James Cross III, Lowell, MA (US); Alexander H. Slocum, Bow, NH (US)

(73) Assignee: 24M Technologies, Inc., Cambridge, MA (US)

(21) Appl. No.: 13/915,312

(22) Filed: Jun. 11, 2013

Related U.S. Application Data
(63) Continuation of application No. PCT/US2011/066902, filed on Dec. 22, 2011.
(60) Provisional application No. 61/426,962, filed on Dec. 23, 2010.

(51) Int. Cl. H01M 8/20; H01M 8/18; H01M 8/24

(52) U.S. Cl. CPC H01M 8/20; H01M 8/24; H01M 8/188
USPC 429/434; 429/457; 429/535

(57) ABSTRACT

A static semi-solid filled energy storage system having a plurality of static cells, each cell comprising an ion permeable membrane separating positive and negative current collectors and positioned to define positive and negative electroactive zones. Electroactive material is delivered to the electroactive zones via a plurality of manifolds. The manifolds are injected with an electronically insulating barrier that is configured to seal each static cell from its neighboring static cell. Valves are used to allow gas created from the electrochemical reactions to be released from the system. Coolant may be introduced to dissipate heat from the system.

### INCORPORATION BY REFERENCE

All patents, patent applications and documents cited herein are hereby incorporated by reference in their entirety for all purposes in order to more fully describe the state of the art as known to those of skill at the time of the invention.

### FIELD OF THE INVENTION

The present invention generally relates to an electrochemical battery cell. More particularly, the present invention relates to materials, design, and manufacturing processes for high-energy density batteries.

### BACKGROUND

Conventional battery systems store electrochemical energy by separating an ion source and ion sink at differing ion electrochemical potential. A difference in electrochemical potential produces a voltage difference between the positive and negative electrodes, which produces an electric current if the electrodes are connected by a conductive element. In a conventional battery system, negative electrodes and positive electrodes are connected via a parallel configuration of two conductive elements. The external elements exclusively conduct electrons, however, the internal elements, being separated by a separator and electrolyte, exclusively conduct ions. The external and internal flow streams supply ions and electrons at the same rate, as a charge imbalance cannot be sustained between the negative electrode and positive electrode. The produced electric current can be used to drive an external device. A rechargeable battery can be recharged by application of an opposing voltage difference that drives electric and ionic current in an opposite direction as that of a discharging battery. Accordingly, active material of a rechargeable battery requires the ability to accept and provide ions. Increased electrochemical potentials produce larger voltage differences between the cathode and anode of a battery, which increases the electrochemically stored energy per unit mass of the battery. For high-power batteries, the ionic sources and sinks are connected to a separator by an element with large ionic conductivity, and to the current collectors with high electric conductivity elements.

Typical battery manufacturing involves numerous complex and costly processes carried out in series, each of which is subject to yield losses, incurs capital costs for equipment, and includes operating expenses for energy consumption and consumable materials. The process first involves making separate anodic and cathodic mixtures that are typically mixtures of electrochemically active ion storage compounds, electronically conductive additives, and polymer binders. The mixtures are coated onto the surfaces of flexible metal foils and subsequently compressed under high pressure to increase density and control thickness. These compressed electrode/foil composites are then slitted into sizes and/or shapes that are appropriate for the particular form factor of the manufactured battery. The slitted electrode composites are typically co-wound or co-stacked with intervening ionically-conductive/electronically-insulating separator membranes to construct battery windings, i.e. “jelly rolls” or “stacks,” which are then packaged in metal cans, flexible polymer pouches, etc. The resulting cells are infiltrated with liquid electrolyte and require a carefully controlled environment.

Redox flow batteries, also known as a flow cells or redox batteries or reversible fuel cells, are energy storage devices in which the positive and negative electrode reactants are soluble metal ions in liquid solution that are oxidized or reduced during the operation of the cell. Using two soluble redox couples, one at the positive electrode and one at the negative electrode, solid-state reactions are avoided. A redox flow cell typically has a power-generating assembly comprising at least an ionically transporting membrane separating the positive and negative electrode reactants (also called cathode semi-solid and anode semi-solid, respectively), and positive and negative current collectors (also called electrodes) which facilitate the transfer of electrons to the external circuit but do not participate in the redox reaction (i.e., the current collector materials themselves do not undergo Faradaic activity). Redox flow batteries have been discussed by M. Bartolozzi, “Development of Redox Flow Batteries: A Historical Bibliography,” J. Power Sources, 27, 219 (1989), and by M. Skyllas-Kazacos and F. Grossmith, “Efficient Vanadium Redox Flow Cell,” Journal of the Electrochemical Society, 134, 2950 (1987), and is hereby incorporated by reference.

Differences in terminology for the components of a flow battery and those of conventional primary or secondary batteries are herein noted. The electrode-active solutions in a flow battery are typically referred to as electrolytes, and specifically as the cathode semi-solid and anode semi-solid, in contrast to the practice in lithium ion batteries where the electrolyte is solely the ion transport medium and does not undergo Faradaic activity. In a flow battery the non-electrochemically active components at which the redox reactions take place and electrons are transported to or from the external circuit are known as electrodes, whereas in a conventional primary or secondary battery they are known as current collectors.

### SUMMARY

Method and apparatus for preparing a energy storage system using flowable energy storage materials is described. Methods and apparatus for eliminating shunt currents in a static redox energy storage system also are described. Because the energy storage material is capable of flow, but is immobilized within the cell during operation, the energy storage system is referred to as a “static semi-solid filled cell” or a “semi-solid cell.”

According to an exemplary aspect, a static semi-solid filled cell energy storage system is provided. The system comprises one or more static cells, the cells including positive and negative current collectors, an ion-permeable membrane separating said positive and negative current collectors, positioned and arranged to define positive and negative electroactive zones. A plurality of manifolds deliver electrode material to the positive and negative electroactive zones. An electronically insulating barrier is configured to seal each static cell. In some embodiments, the manifolds are used to deliver electrode material to the positive and negative electroactive zones during the production of the battery assembly and can be removed after the battery has been assembled.

According to an exemplary embodiment, a static semi-solid filled cell energy storage system is provided. The system comprises a plurality of static cells, wherein each cell has a positive and negative electrode current collectors, and an ion-permeable membrane separating the positive and negative current collectors, positioned and arranged to define a positive and negative electroactive zone, a plurality of manifolds configured to deliver flowable electrode material to a defined positive and negative electroactive zone within the static cell, and an electronically insulating barrier configured to seal each static cell from the other. Optionally, the manifolds can be removed after the battery has been assembled.

In the preceding embodiment, the energy storage system comprises at least one of an inlet and outlet port to allow a cooling substance to circulate throughout cell and dissipate heat from the cell.

In any of the preceding embodiments, the energy storage system comprises at least one valve to allow gas to be released from the static cell.

In any of the preceding embodiments, the electrode material is configured to be reconditioned after being depleted.

In any of the preceding embodiments, the electronically insulating barrier is configured such that it can be inserted and removed from the manifolds.

In any of the preceding embodiments, the energy storage system comprises a device configured to add a salt suspension to the electrode material housed in the static cell.

In the preceding embodiment, wherein the electrode material comprises ion storage compound particles having a polydisperse size distribution in which the finest particles present in at least 5 vol % of the total volume, is at least a factor of 5 smaller than the largest particles present in at least 5 vol % of the total volume.

In any of the preceding embodiments, the electrode material comprises an electrically conductive additive.

In any of the preceding embodiments, the electrode material comprises a redox mediator.

In any of the preceding embodiments, the electrode materials include particles with a diameter of at least 1 micrometer.

In any of the preceding embodiments, the electrode materials include particles with a diameter of at least 10 micrometers.

In one aspect, a static semi-solid filled cell energy storage system is described, comprising:
(a). a static cell stack comprising one or more static semi-solid filled cells, each cell comprising a positive electrode current collector, a negative electrode current collector, and an ion-permeable membrane separating said positive and negative current collectors, positioned and arranged to define a positive electroactive zone and a negative electroactive zone;
(b). a plurality of manifolds, wherein
   i. a first manifold is configured to deliver a flowable cathode material to the positive electroactive zone first location of the static cell,
   ii. a second manifold is configured to deliver flowable anode material to the a negative electroactive zone second location of the static cell; and
(c). an electronically insulating barrier housed within the first and second manifolds and configured to seal each said static cell from its neighboring static cell.

In any of the preceding embodiments, the static energy storage system further includes at least one inlet port and outlet port configured to allow a cooling substance to circulate through the static cell to dissipate heat from the cell.

In any of the preceding embodiments, the static energy storage system further includes at least one valve configured to allow gas to be released from the static cell, wherein cathode material is associated with the gas.

In any of the preceding embodiments, the static energy storage system further includes at least one valve configured to allow gas to be released from the static cell, wherein the anode material is associated with the gas.

In any of the preceding embodiments, the cathode and anode semi-solids are configured to be reconditioned after depletion of at least a portion at least one of the cathode or anode semi-solids.

In any of the preceding embodiments, the electronically insulating barrier is threaded such that they can be inserted and removed from the manifolds.

In any of the preceding embodiments, the static energy storage system further includes a device configured to add a salt suspension to the electrode material housed in the first and second location of the static cell.

In any of the preceding embodiments, at least one of the cathode material and the anode material comprises ion storage compound particles having a polydisperse size distribution in which the finest particles present in at least 5 vol % of the total volume, is at least a factor of 5 smaller than the largest particles present in at least 5 vol % of the total volume.

In any of the preceding embodiments, at least one of the cathode material and the anode material comprises an electrically conductive additive.

In any of the preceding embodiments, at least one of the cathode material and the anode material further comprises a redox mediator.

In any of the preceding embodiments, at least one of the cathode and anode materials include particles with a diameter of at least 1 micrometer.

In any of the preceding embodiments, at least one of the cathode and anode material include particles of at least 10 micrometers.

In any of the preceding embodiments, the plurality of manifolds are removable.

In another aspect, a method of manufacturing a static cell energy storage system is described, including:
(a). providing a static cell, wherein the static cell has a first subassembly for housing a cathode semi-solid and a second subassembly for housing an anode semi-solid;
(b). connecting the static cell to a first manifold configured to deliver the cathode semi-solid to the first subassembly;
(c). connecting the static cell to a second manifold configured to deliver the anode semi-solid to the second subassembly;
(d). transferring cathode and anode semi-solids from a location external to the static cell to the first and second subassemblies through the first and second manifolds;
(e). inserting an electronically insulating member into the inlet and outlet of the first manifold to thereby isolate each first subassembly; and
(f). inserting an electronically insulating member into the inlet and outlet of the second manifold to thereby isolate each second subassembly.

In any of the preceding embodiments, the first and second locations of the static cell are preconfigured to comprise a powdered substance.

In any of the preceding embodiments, the temperature of the first and second locations are increased prior to the addition of cathode or anode material.

In any of the preceding embodiments, at least one of the cathode material and anode material are introduced into the respective subassembly in a first chemical state and converting the at least one of the cathode material and anode material into second chemical state in the respective subassembly, said first state have a lower viscosity than the second state.

In any of the preceding embodiments, the chemical state of the at least one of the cathode material and anode material is chemically converted by adding a salt to the respective subassembly after introduction of the cathode and anode material.

In any of the preceding embodiments, at least one of the cathode material and the anode material is introduced into the respective subassembly as a powdered substance.

In any of the preceding embodiments, the method further includes adding an electrolyte into the respective subassembly after introduction of the powdered substance.

In any of the preceding embodiments, the method further includes increasing the temperature of the first and second subassemblies prior to the cathode or anode semi-solids entering the first and second manifold.

In any of the preceding embodiments, the method further includes at least one of the cathode and anode material is introduced as a foam.

In yet another aspect, a method of manufacturing a static cell energy storage system is described, including:
(g). providing a static cell, wherein the static cell has a first subassembly for housing a cathode semi-solid and a second subassembly for housing an anode semi-solid; wherein the first subassembly comprises one or more first openings for receiving the cathode semi-solid and the second subassembly comprises one or more second openings for receiving the anode semi-solid;
(h). connecting the static cell to a first manifold configured to deliver the cathode semi-solid to the first subassembly;
(i). connecting the static cell to a second manifold configured to deliver the anode semi-solid to the second subassembly;
(j). transferring cathode and anode semi-solids to the first and second subassemblies through the first and second manifolds; and
(k). removing the first and second manifolds and sealing the first and second openings.

### BRIEF DESCRIPTION OF THE DRAWINGS

The invention is described with reference to the following figures, which are provided for the purpose of illustration only, the full scope of the invention being set forth in the claims that follow.

FIG. 1 illustrates a schematic illustration of a static multi-cell stack system according to an embodiment.

FIG. 2 illustrates a perspective view of a constructed multi-cell stack system, according to an embodiment.

FIG. 3A illustrates a perspective cross-section view of the constructed multi-cell stack system of FIG. 2, while FIG. 3B illustrates an exploded view of an anode plates, an anode starter plate, a cathode plate, a current collector, and a membrane separator disposed in the multi-cell stack system of FIG. 2.

FIG. 4A illustrates a rear perspective view, and FIG. 4B illustrates a front perspective view, of a constructed multi-cell stack system with electronically insulating pushing rods disposed out, according to an embodiment. FIG. 4C illustrates a rear perspective view of the multi-cell stack with the pushing rods disposed in. FIGS. 4D-4H are schematic illustrations of the process of filling the multi-cell stack with semi-solid catholyte and anolyte and sealing the multi-cell stack using pushing rods, according to an embodiment.

FIGS. 5A-5E are schematic illustrations of the process of filling a multi-cell stack with semi-solid catholyte and anolyte and sealing the multi-cell stack using a sealant, according to an embodiment.

FIG. 6 illustrates a perspective view of a textured current collector.

FIG. 7 illustrates a method of manufacturing a filled multi-cell stack system.

FIG. 8 illustrates an alternative method of manufacturing a filled multi-cell stack system.

FIG. 9 illustrates an exploded perspective view of a filled multi-cell stack system, according to an embodiment.

FIG. 10 illustrates data results from an electrochemical test performed on a system made in accordance with the present invention.

FIG. 11 shows a perspective view of a portion of an external manifold assembly used in the production of a battery assembly.

### DETAILED DESCRIPTION OF EXEMPLARY, NON-LIMITING EMBODIMENTS OF THE INVENTION

Exemplary embodiments of the present invention provide a semi-solid battery device that utilizes chambers filled with electrochemically active semi-solids or packed electrochemically active particles. The design provides an economic benefit and reduces manufacturing complexity by producing particulate based anodes and cathodes in a pre-assembled compartments, current collectors, and separators. Furthermore, the design is used with non-aqueous and aqueous electrolyte battery chemistries. One or more embodiments of the invention can also be used on any other suitable battery cells beyond those described herein.

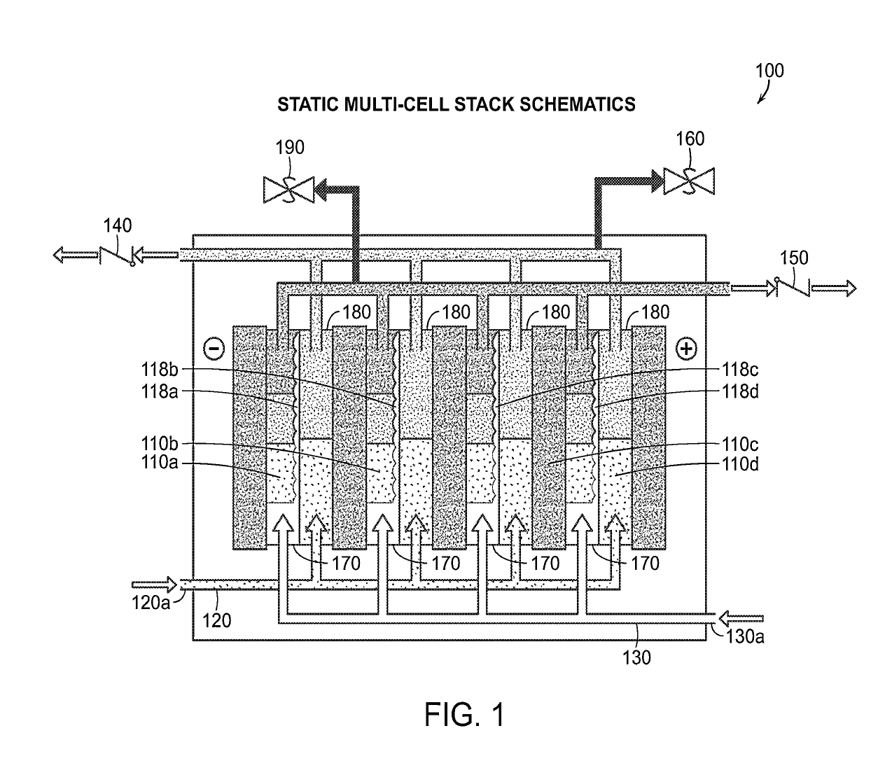

Features of a static cell in accordance with an exemplary embodiment are shown in FIG. 1. FIG. 1 illustrates a static multi-cell stack system 100, which includes cells 110a, 110b, 110c, and 110d. Cells 110a, 110b, 110c, and 110d include a positive electrode current collector (not shown) and a negative electrode current collector (not shown), separated by an ion permeable separator 118a, 118b, 118c, 118d. Current collectors may be in the form of a thin sheet and are spaced apart from the separators. Positive electrode current collector and ion permeable separator define an area 180, hereinafter referred to as the “positive electroactive zone” that accommodates the positive flowable electrode active material. Negative electrode current collector and ion permeable separator define an area 170, hereinafter referred to as the “negative electroactive zone” that accommodates the negative flowable electrode active material. In manufacture of the static cell, positive and negative electrode (e.g., cathode and anode respectively) material are introduced to cells 110a-d, via manifolds 120 and 130, respectively. It should be appreciated that a cell is represented by the pairing of a cathode compartment 180 and an anode compartment 170. For example, cathode material enters manifold 120 at inlet port 120a. Manifold 120 delivers the cathode material, which was previously stored external to system 100, to the multiple cathode compartments 180. Similarly, anode material is introduced to system 100 through manifold 130 via inlet port 130a. Prior to this process, cathode and anode compartments 180 and 170 are substantially free of electrode material.

At least one of the positive electrode or negative electrode-active materials may include a semi-solid or a condensed ion-storing liquid reactant. By “semi-solid” it is meant that the material is a mixture of liquid and solid phases, for example, such as a semi-solid, particle suspension, colloidal suspension, emulsion, gel, or micelle. “Condensed ion-storing liquid” or “condensed liquid” means that the liquid is not merely a solvent as it is in the case of an aqueous flow cell catholyte or anolyte, but rather, that the liquid is itself redox-active. Of course, such a liquid form may also be diluted by or mixed with another, non-redox-active liquid that is a diluent or solvent, including mixing with such a diluent to form a lower-melting liquid phase, emulsion or micelles including the ion-storing liquid.

The cathode or anode material is flowable semi-solid or condensed liquid compositions. A flowable anodic semi-solid (herein called “anolyte”) and/or a flowable cathodic semi-solid (“catholyte”) are/is comprised of a suspension of electrochemically-active agents (anode particulates and/or cathode particulates) and, optionally, electronically conductive particles. These flowable semi-solids are used to fill compartment 180 or 170. The cathodic particles and conductive particles are co-suspended in an electrolyte to produce a catholyte semi-solid. The anodic particles and conductive particles are co-suspended in an electrolyte to produce an anolyte semi-solid. The semi-solids are capable of flowing due to an applied pressure, gravitational force, or other imposed field that exerts a force on the semi-solid, and optionally, with the aid of mechanical vibration.

During manufacture of cells according to embodiments of the present invention, anolyte and/or catholyte is introduced into the unfilled battery compartments, i.e., 180 and 170, prior to the battery being sealed. The flowable semi-solid is introduced into compartments 170, 180 to load the cell using any acceptable method. For example, the flow of cathode or anode material into system 100 may be initiated or facilitated by vibration, sonic agitation, or shearing. This flow initiation may occur prior to the materials entering compartments 180 and 170 to decrease viscosity and promote suspension stability. Once loaded, the individual cells are sealed (as is discussed in greater detail below) and each cell operated in physical isolation, but electrical connection, with adjacent cells.

This design provides for a battery unit to adopt various form factors, which allows for a battery to be constructed into specialized shapes and sizes for particular applications. The shape and design of cathode and anode compartments (180, 170) determines that of the resulting battery. The use of varying electrode material, e.g., semi-solid constituents, separator, and compartment volumes determine the battery's power and energy capabilities.

System 100 also includes cathode and anode check valves 140 and 150, respectively. The check valves are designed to allow for the flow of cathode or anode material into the cathode or anode compartment, respectively, during the production of the cell. Check valves 140 and 150 prevents leakage of electrode material from system 100. Cathode relief valve 160 allows for the release of gaseous reactants formed in cathode compartments 180. Anode relief valve 190 allows for the release of gaseous reactants formed in anode compartments 170. Cathode check valve 140 and anode check valve 150 allows for the flow of cathode or anode material to be shut off during the course of operation of a cell. Check valves 140 and 150 prevents leakage of electrode material from system 100.

The composition of the semi-solid electrolyte is selected to improve material flow and packing uniformity and density in the static flow cell.

In some embodiments, the cathode or anode particles have effective diameter of at least 1 micrometer and preferably at least 10 micrometers.

In some embodiments, in order to increase the particle packing density and therefore the energy density of the semi-solid suspension, while still maintaining a flowable semi-solid, the ion storage compound particles have a polydisperse size distribution in which the finest particles present in at least 5 vol % of the total volume, is at least a factor of 5 smaller than the largest particles present in at least 5 vol % of the total volume.

In some embodiments, in order to increase the particle packing density and therefore the energy density of the semi-solid suspension, while still maintaining a flowable semi-solid, the ion storage compound particles have a bidisperse size distribution (i.e., with two maxima in the distribution of particle number versus particle size) in which the two maxima differ in size by at least a factor of 5.

In some embodiments, the sized distribution of ion storage compound particles in the semi-solid is polydisperse, and the particle packing fraction is at least 50 vol %, preferably at least 55 vol %, more preferably at least 60 vol %, still more preferably at least 65 vol %, and still more preferably at least 70 vol %.

In some embodiments, the particles have morphology that is at least equiaxed, and preferably spherical, in order to increase the flowability and decrease the viscosity of the semi-solid suspension while simultaneously achieving high particle packing density. In some embodiments the spherical particles are dense, and in other embodiments the spherical particles are porous. In some embodiments, the spherical particles are made by spray-drying a particle suspension to obtain spherical agglomerates of smaller particles.

In some embodiments, the particles of ion storage material used in the semi-solid suspension are sufficiently large that surface forces do not prohibit them from achieving high tap density while dry, and high packing density when formulated into a semi-solid suspension. In some embodiments, the particle size is at least 1 micrometer and preferably at least 10 micrometers.

In some embodiments, high particle packing density is achieved simultaneously with flowability and low viscosity by using dispersants and surfactants well-known to those skilled in the arts of ceramics processing and colloid chemistry. These additives may be, for example, organic molecules having a C₆ to C₁₂ backbone used to provide steric forces when adsorbed on the particles. Examples of such additives include stearic acid, and the commercially available surfactant Triton-X-100.

In some embodiments, a redox mediator is used to improve charge transfer within the semi-solid suspension. In some embodiments the redox mediator is based on Fe²⁺ or V²⁺, V³⁺, or V⁴⁺. In one embodiment the redox mediator is ferrocene.

In one embodiment, the flow battery uses dissolved redox ions as in a conventional aqueous or nonaqueous flow battery, but the anolyte and/or catholyte has a increased solubility for such ions by using as the solvent an ionic liquid. In some embodiments, the redox chemistry is Fe—Cr, vanadium redox, or a zinc-halogen chemistry.

In some embodiments, the conductive particles have shapes which may include spheres, platelets, or rods which optimize solids packing fraction, increase the semi-solid's net electronic conductivity, and improve rheological behavior of the semi-solids. Low aspect or substantially equiaxed particles tend to flow well, however, they tend to have a low packing density.

In some embodiments, the particles have a plurality of sizes so as to increase packing fraction by placing smaller particles in the interstices of the larger particles. In particular, the particle size distribution can be bimodal, in which the average particle size of the larger particle mode is at least 5 times larger than the average particle size of the smaller particle mode. The mixture of large and small particles improves flow of the material during cell loading and increases solid volume fraction and packing density in the loaded cell.

In some embodiments, the nature of suspension can be modified prior to and subsequent to injection of the semi-solid into the unfilled-battery-subassembly receptacles in order to facilitate flow during loading and packing density in the loaded cell.

In some embodiments, the particle suspension is initially stabilized by repulsive interparticle steric forces that arise from surfactant molecules. After the particle suspension is injected into the unfilled-battery-subassembly receptacles, chemical or heat treatments can cause these surface molecules to collapse or evaporate and promote densification. In some embodiments, the suspension's steric forces are modified intermittently during injection.

For example, the particle suspension can be initially stabilized by repulsive interparticle electrostatic-double-layer forces to decrease viscosity. The repulsive force reduces interparticle attraction and reduces agglomeration. After the particle suspension is injected into the unfilled-battery-subassembly receptacles, the surface of the particles can be further modified to reduce interparticle repulsive forces and thereby promote particle attraction and packing. For example, ionic solutions such as salt solutions can be added to the suspension reduce the repulsive forces and promote aggregation and densification so as to produce increased solids fraction loading after injection. In some embodiments, salt is added intermittently during suspension injection to increase density in incremental layers.

In some embodiments, the cell compartments are loaded with a particle suspension that is stabilized by repulsive forces between particles induced by an electrostatic double layer or short-range steric forces due to added surfactants or dispersants. Following loading, the particle suspension is aggregated and densified by increasing the salt concentration of the suspension. In a preferred embodiment, the salt that is added is a salt of a working ion for the battery, e.g. is a lithium salt for a lithium ion battery, and upon being added, causes the liquid phase to become an ion-conducting electrolyte. The liquid phase comprises a solvent that is then used as the solvent component of the electrolyte, e.g., for a lithium rechargeable battery, may be one or more alkyl carbonates, or one or more ionic liquids. Upon increasing the salt concentration, the electrical double layer causing repulsion between the particles is “collapsed,” and attractive interactions cause the particles to floc or aggregate or consolidate or densify. This allows the electrode of the battery to be formed from the suspension while it has a low viscosity, for instance by pouring or injection or pumping into the chamber that forms a net-shaped electrode, and then allows particles within the suspension to be consolidated for improved electrical conduction, higher packing density, and longer service life.

In some embodiments, the injectable and flowable semi-solid is caused to become non-flowable by “fixing.” In some embodiments, fixing is performed by action of photo-polymerization. In some embodiments, fixing is performed by action of electromagnetic radiation with wavelengths that are transmitted by the unfilled-battery-subassembly. In some specific embodiments, one or more additives are added to the flowable semi-solid to facilitate the fixing of the flowable semi-solid.

In some embodiments, the injectable and flowable semi-solid is caused to become non-flowable by “plasticizing.” In some embodiments, the rheological properties of the injectable and flowable semi-solid are modified by addition of a thinner, a thickener, or a plasticizing agent. In some specific embodiments, these agents promote processability and help retain compositional uniformity of the semi-solid under flowing conditions and compartment filling operations. In some specific embodiments, one or more additives are added to the flowable semi-solid to adjust its flow properties to accommodate processing requirements.

In some embodiments, the semi-solid is adjusted to match prescribed environmental conditions such as temperature, temperature-variation, vibration, pressure, radiation, and magnetic fields.

In some embodiments, the receptacles are preheated and filled with elevated temperature semi-solids. In some embodiments, the ambient temperature semi-solid is not a flowable medium. In some embodiments, the semi-solid is subjected to microwave radiation during injection.

In some embodiments, the electrochemically active and conductive particles are suspended in a foam and caused to flow into the unfilled-battery-subassembly receptacles. In some embodiments, conductive particulates are co-suspended in the foam. In some embodiments, the foaming media is composed of a conductive polymer. In some embodiments, liquid electrolyte is caused to infiltrate the foam after filling. In some embodiments, the liquid electrolyte has the effect of collapsing the foam so as to increase the solids fraction of the resulting structure.

Alternatively, flowable dry or substantially dry powders from the semi-solids are used to fill cathode and anode compartments (180, 170). The powder is capable of flowing under an applied pressure, gravitational force, or other imposed field that exerts a force on the particles, and optionally with the aid of mechanical vibration. A liquid electrolyte or semi-solid mixture of liquid electrolyte and conductive particles and/or ion storage particles is then used to fill the space between the dry powder particles in the cathode or anode.

In some embodiments, the receptacles are filled with dry powder mixtures and subsequently infiltrated with a fluid electrolyte or semi-solid mixture of electrolyte and solid particles. In some embodiments the solid particles are electronic conductors, ionic conductors, ion storage compounds, or getters for water, acid, or other impurities in the electrolyte.

In some embodiments, the receptacles are filled with dry powders of larger electrochemically active particles and subsequently infiltrated with a plurality of active-particle/conductive/electrolyte semi-solids described above. This two-step filling process increases solids loading fraction with a multiplicity of active particle sizes.

Once the cell compartments are loaded with electroactive semi-solid, the individual cells are isolated from adjacent cells in order to prevent shunt currents from occurring. Because the electrode materials are fed into the cell compartments through a common manifold, during operation of the device, shunt current may occur to bypass one or more cell compartments in the device. The occurrence of shunt current from cathode to cathode and anode to anode will decrease the stack voltage.

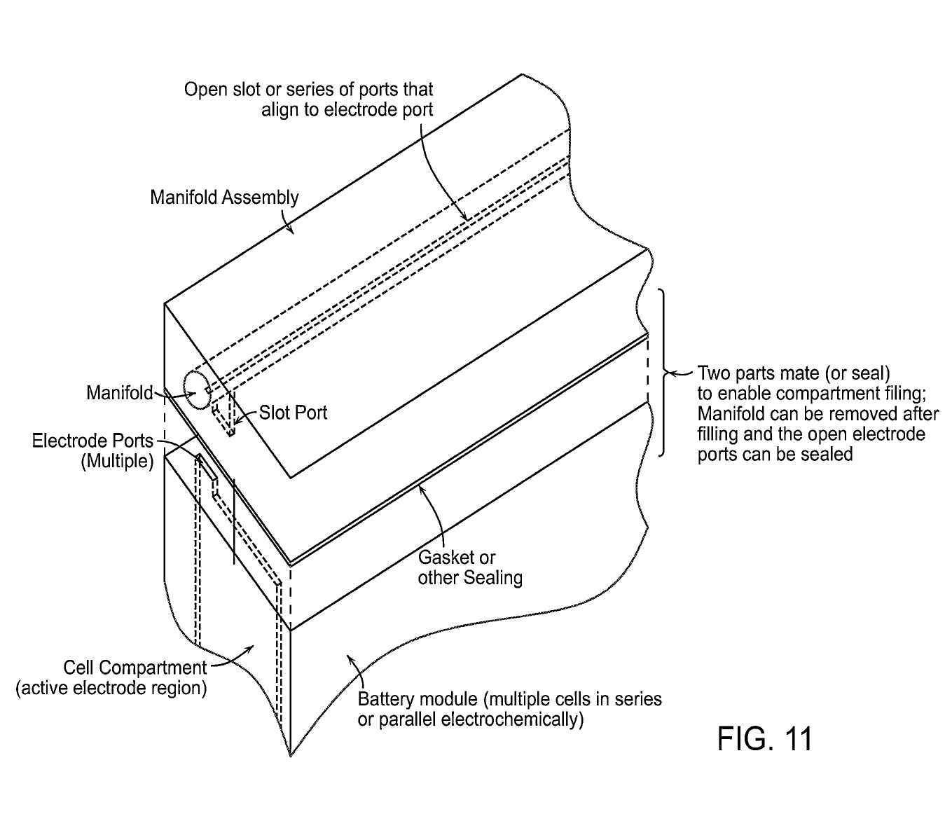

In some embodiments, one or more external manifolds can be used to introduce the flowable semi-solid electroactive materials into the electrode compartments and the external manifolds can be removed after the production of the battery. An illustrative example is shown in FIG. 11. In this case the manifold facilitates introduction of electrode materials (prepared semi-solids or alternatively staged components thereof) to the compartments, but is removed after filling. The manifold assembly may be pre-charged with material or empty prior to affixing to the battery module. The manifold assembly and battery module are sealed together, e.g. using a peripheral gasket. The manifold itself may have a single slot-type exit port (see FIG. 11), a multiplicity of slot-type ports, or a multiplicity of individualized ports, each one aligning to an electrode port. Compartment filling is accomplished by any one of a number of means, including mechanical pushing, application of a pressure differential between inlet and outlet which includes both upstream pressurization, downstream suction, or both, gravity, vibration, or combination thereof, or any of the variants described within this specification. In some embodiments, the fluid containing the semi-solid flows into the compartments through the manifold. In other embodiments, the fluid containing the semi-solid is pre-charged into the manifold and flow into compartments via external forces. For instance, a piston or a pressure can be applied to facilitate the flow. The manifold assembly may be removed subsequent to compartment filling, at which time the electrode ports will be sealed—e.g. using an applied curing substance such as epoxy, an inserted mechanical part or bank of such parts, a face plate with suitable sealing features, a hermetic pouch or bag enclosing the entire battery module, or combinations and variants thereof.

As shown in FIG. 11, the external manifold resides on the upstream side of the battery assembly. In other embodiments, the external manifold resides on the downstream side or the exit side of the battery assembly. In still other embodiments, two external manifolds can be used and one external manifold resides on the upstream side and the other external manifold resides on downstream side or the exit side of the battery assembly.

In some embodiments, a sealant is injected into the semi-solid feed ports after filling.

In some embodiments, a non-conductive sealant is injected into the semi-solid feed ports after filling.

In some embodiments, a non-conductive rod is injected into a single semi-solid feed port which displaces the fraction of semi-solid within the manifold and remains there to provide a shunt current prevention device.

In some embodiments, a non-conductive sealant is injected into a single semi-solid feed port which displaces the fraction of semi-solid within the manifold and remains there to provide a shunt current prevention device.

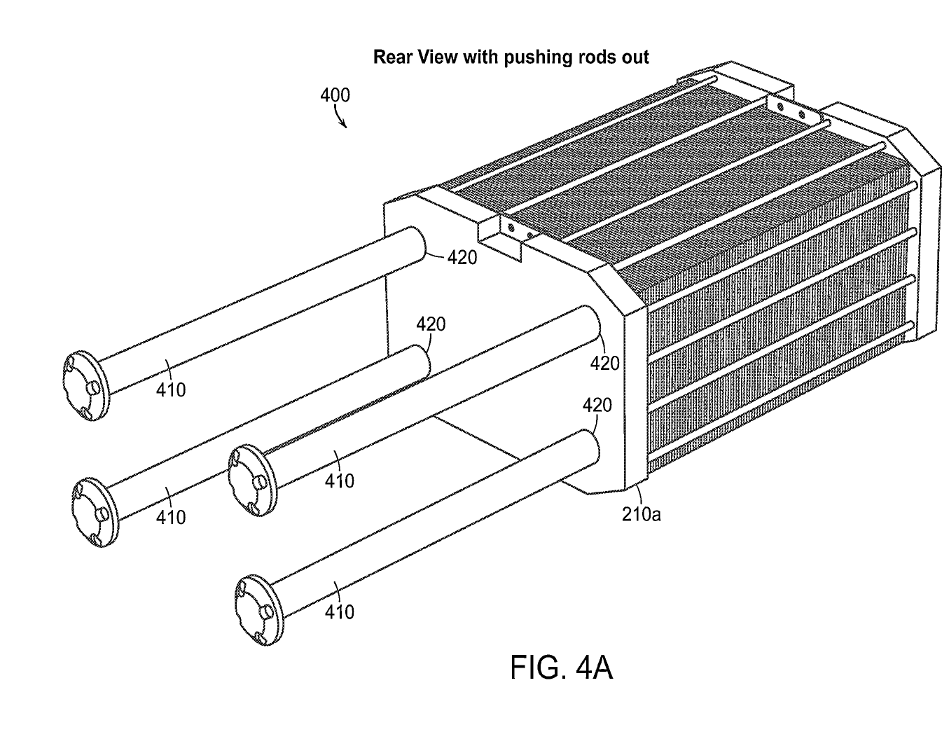

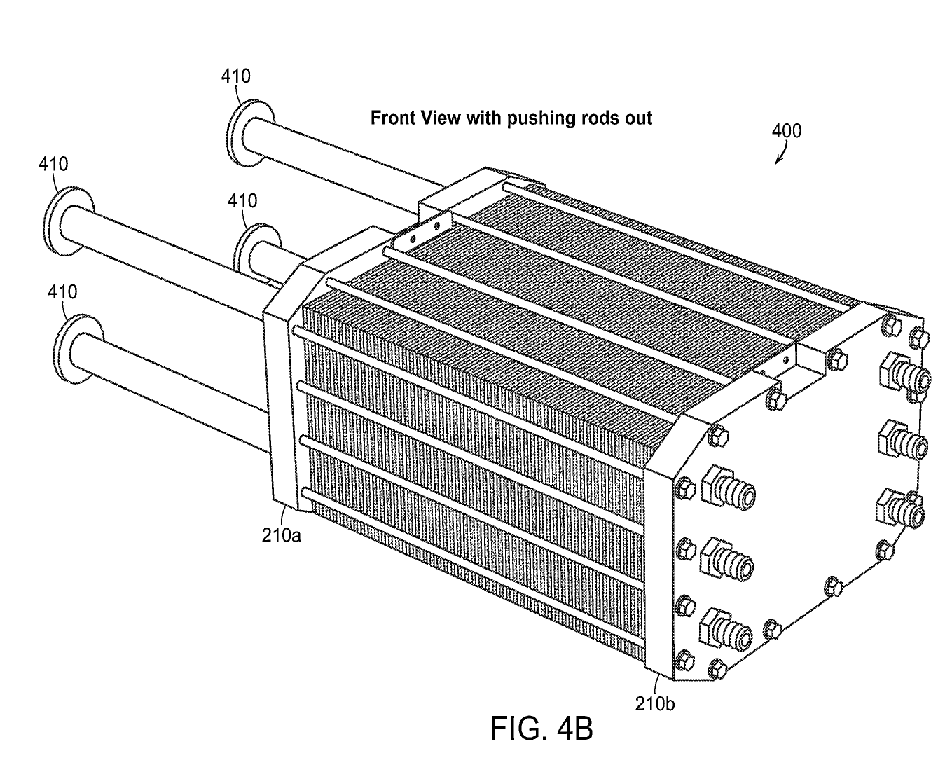

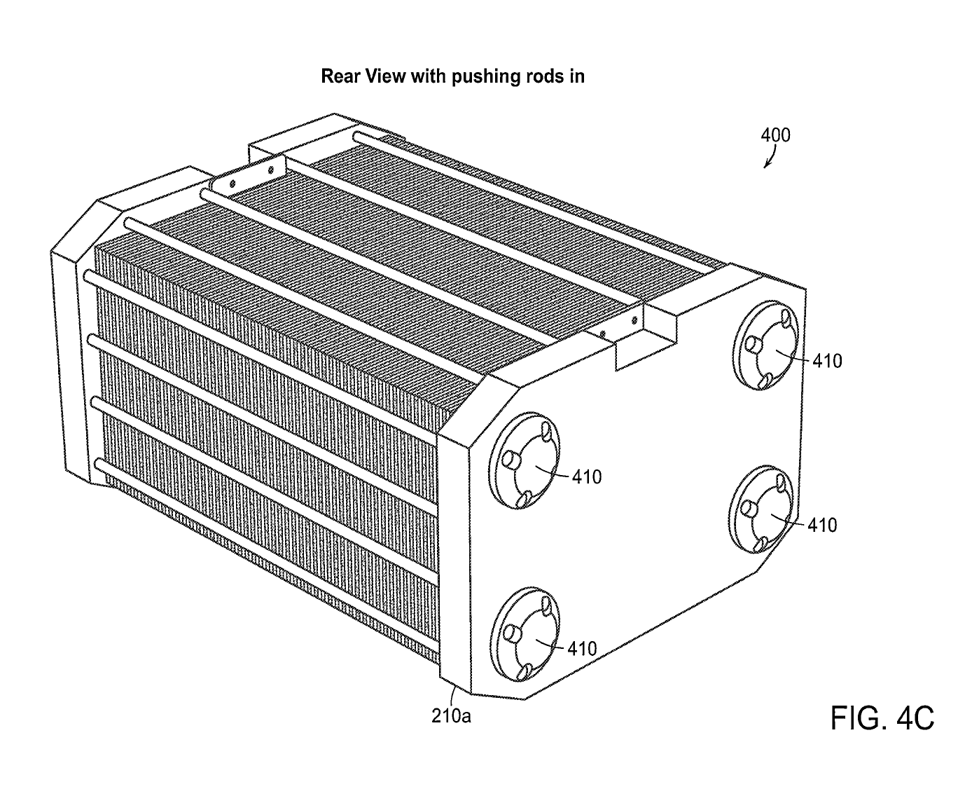

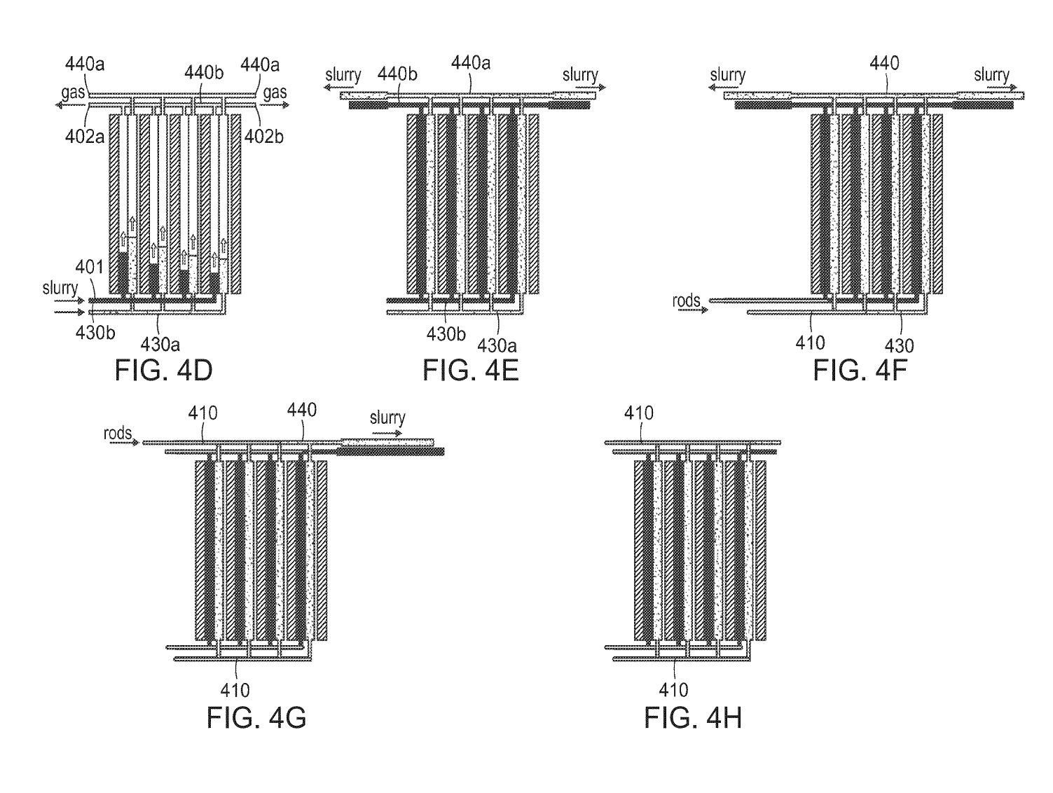

FIGS. 4A, 4B, and 4C illustrate various views of a constructed multicell stack according to the present invention. These figures describe the isolation of a filled cell stack. Stack 400 is a multicell stack such as illustrated in FIG. 1. It should be appreciated that there is at least one manifold for receiving anolytes and at least one manifold for receiving catholytes. Referring also now to FIGS. 4D-4H, flowable positive electrode or negative electrode-active semi-solid materials are introduced into stack 400 through inlet manifolds 430a and 430b respectively, displacing gas in the individual cells, as shown in FIG. 4D. For example, catholyte and anolyte semi-solids, introduced via ports 420, are injected into the unfilled sub-assemblies (not shown) located in each cell included in system 400. Ports 420 are located on back plate 210a shown in FIG. 4A. It should be appreciated that in this embodiment, the cathode and anode inlet valves are closed, whereas catholyte and anolytes are forced through the cathode and anode manifolds inside multicell stack 400. The electrolytes are injected into the system until the semi-solids have displaced the complete volume of their respective receptacles. As shown in FIG. 4E, an overflow can occur when cathode or anode semi-solid is injected into the system. Once the semi-solid completely fills the compartment volume as shown in FIG. 4E, electronically insulating rods 410 are inserted into manifolds 430a and 430b, also as shown in FIG. 4F. Rods 410 are subsequently inserted through ports 401 and into inlet manifolds 430a, 430b. This displaces the semi-solid within the manifold and extrudes excess semi solid through the exit ports in the exit manifolds 440a, 440b and seals the entrance into each of the individual cells. Although exit manifolds 440a and 440b has openings on both ends, alternative embodiments may include an exit manifold with a single opening. After rod 410 has been inserted into inlet manifolds 430a and 430b via entry port 401, a second rod is inserted into exit manifolds 440a and 440b, via port 402a. This displaces the semi-solid, and excess semi-solid is extruded through the remaining open exit port 402b. The second rod also seals the exit from each of the cells, thereby effectively isolating each cell from its neighbors. While the multi-stack 400 is in use, the rods 410 remain in place, which provides resistance to shunt currents. The cells still remain in electrical connection through wiring between the respective current collectors.

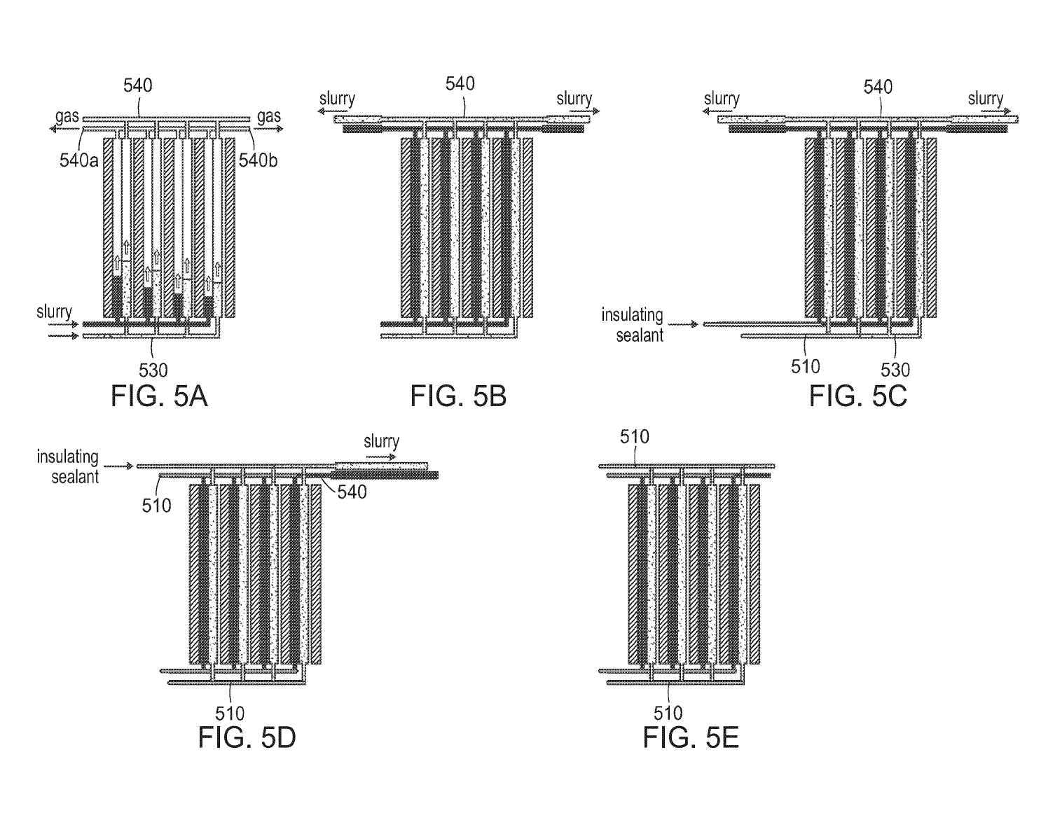

FIGS. 5A-5E show an alternative embodiment for the sealing off of the individual cells. Similar to FIG. 4, in this embodiment catholytes and anolytes are injected into cell 500. However, an electronically insulating sealant 510 is injected into the cell, as opposed to rods. The sealant also remains in the cell and provides resistance to shunt currents

It is contemplated that the rods and/or insulating sealants can be removed. For example, the rods can be threads and can be screwed into and out of the manifold passages. In one or more embodiments, the rods and/or insulating sealant is removed and the flow cell stack is drained of electrode materials. The cells can then be cleaned and recharged with fresh material.

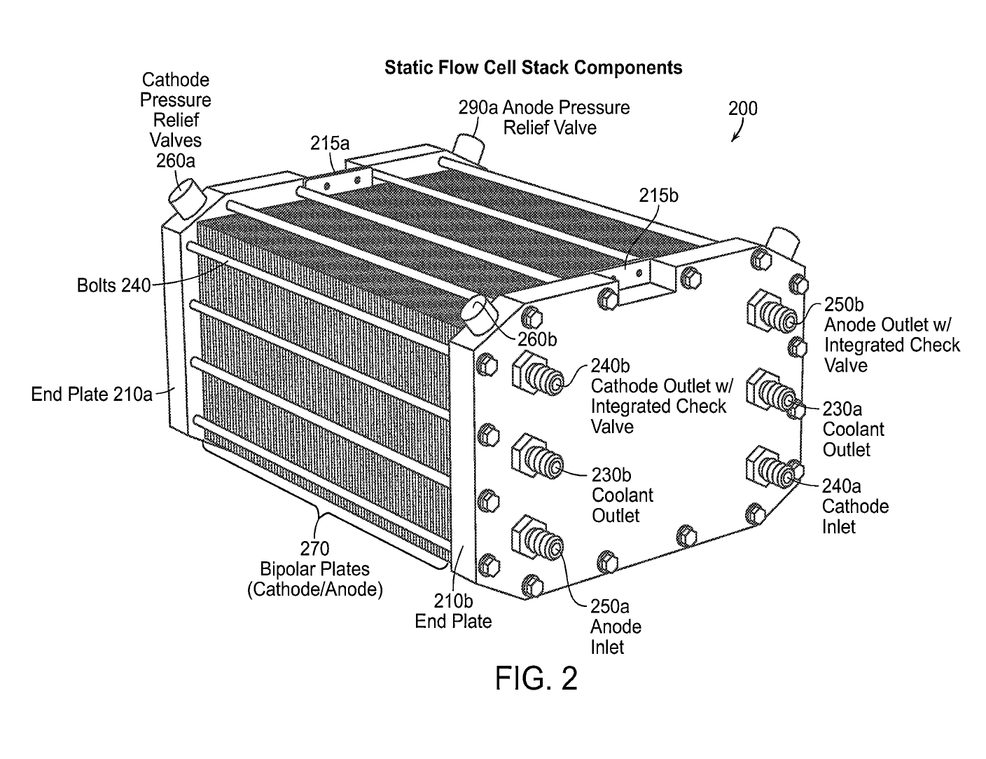

FIG. 2 is an alternative embodiment of a constructed static cell system. As shown, this constructed version of system 100 incorporates current collectors (215a, 215b), end plates (210a, 210b), and a plurality of bolts 240 that are used to maintain system 200 between end plates 210a and 210b. Similar to FIG. 1, system 200 includes cathode inlet 240a and anode inlet 250a, which allows cathode and anode material, respectively, to be introduced into system 200. Although not shown, inlets 240a and 250a are connected to a manifold device that distributes electrode material to each cell included in the multi-stack system. Cathode outlet 240b and anode outlet 250b allows for the exit of cathode and anode material, respectively. For example, the electrode material used within system may be recharged by causing depleted material to exit system 200 via outlet ports 240b and 250b. Relatively low solids fraction semi-solids may be injected into the inlet ports; however supernatant suspension fluid may be extracted via outlet ports. Once removed, the electrode material may be reconditioned for possible reuse. In this embodiment, check valves are integrated into outlet ports 240b and 250b. Additionally, cathode and anode pressure relief valves (260a, 260b, 290a, and 290b) provide for the release of gaseous buildup related to the use of electrode materials. Alternatively, a vacuum may be applied to extract gas from the system.

System 200 also includes coolant ports 230a and 230b. In an exemplary embodiment, coolant material, introduced via port 230a, is circulated through channels between cathode and anode plates 270. The coolant is continuously fed into system 200 during operation. Coolant material that has circulated exits system 200 at outlet port 230b. The coolant can be any suitable material that will allow system 200 to dissipate heat as a result of the operation of the multiple cells. It should be appreciated cells included in system 200, are comprised of bipolar plates. Accordingly, each cell has a subassembly for cathode material and a separate subassembly for anode material.

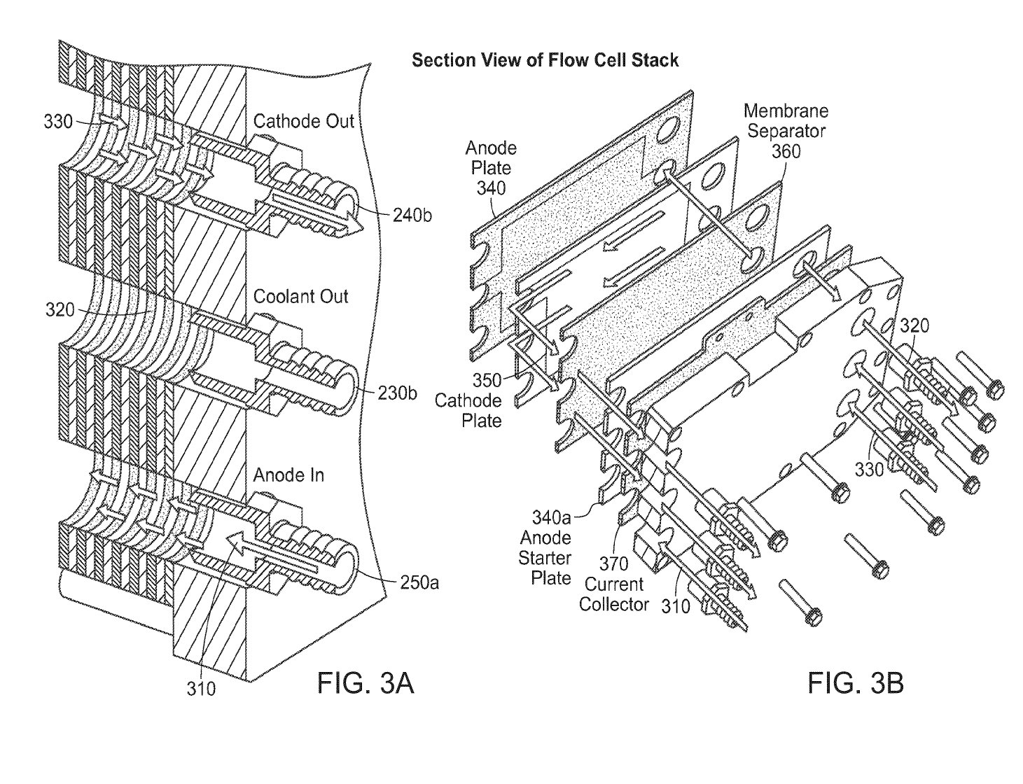

FIG. 3A is a side cross-section view of system 200. Referring also now to FIG. 3B, arrows 310, 320, and 330 show the direction of flow of anode, coolant, and cathode materials introduced into system 200. For example, cathode material enters the system via inlet port 240a and is transferred to cathode plate 340. Similarly, anode material enters the system via inlet port 250a and is transferred to anode plate 350. As shown, coolant enters the system via inlet port 230a and is circulated throughout the entire system 200. Electrode and coolant materials enter system 200 via inlet ports and pass through corresponding openings in current collector 370, anode starter plate 340a, and membrane separator 360 before reaching either the cathode or anode plate 350, 340, respectively.

In preferred embodiments, the unfilled-battery-subassembly has the architecture of a bipolar stack which subsequent to filling becomes a bipolar battery.

In some embodiments, the unfilled-battery-subassembly includes a conduit for a coolant fluid that circulates during operation.

In some embodiments, the ion-permeable membrane includes polyethyleneoxide (PEO) polymer sheets or Nafion membranes.

In some preferred embodiments, unfilled-battery-subassembly's receptacles aspect ratio is such that the areas facing the current collector and separators are large compared to the distance between the separator and the current collector.

In some embodiments, current and/or voltage connections to the electrode current collectors are integrated components of the unfilled-battery-subassembly prior to semi-solid filling.

In some embodiments, current and/or voltage connections to the electrode current collectors are assembled after semi-solid filling.

In some embodiments, the redox flow energy storage device further includes one or more reference electrodes.

In some embodiments, the electrode current collectors are reticulated to increase their surface area relative to the surface area projected onto the collector plane.

In some embodiments, the electrode current collectors are a foam, weave, mesh, or plate with a surface that is ridged, grooved, or otherwise reticulated.

In some embodiments, the electrode current collectors are shaped in order to decrease the distance between active particles and the electrode current collector within the working electrode.

In some embodiments, the separators are shaped in order to decrease the distance between active particles and the separator within the working electrode.

In some embodiments, the unfilled-battery-subassembly dimensions coincide with standard prismatic batteries.

In some embodiments, the unfilled-battery-subassembly dimensions coincide with standard cylindrical batteries.

In some embodiments, the unfilled-battery-subassembly external shape is constructed to maximize its usability in another device such as a car. Examples of such shapes include tubes with bends, wedges, and semi-toruses.

In some embodiments, the unfilled-battery-subassembly incorporates one-way-flow-control gas vents that permit removal of gaseous reactants that may form during battery manufacturing, during initial electrochemical conditioning of the battery (referred to as “formation”), or during use.

In some embodiments, the unfilled-battery-subassembly has input feed ports each of which supplies a multiplicity of cathode and/or anode chambers. In some embodiments, a insulating is inserted so as to fill the entire length of single input feed port. The rod acts as a shunt current eliminator during battery usage in a bipolar device.

In some embodiments, the unfilled-battery-subassembly has input feed ports each of which supplies a multiplicity of cathode and/or anode chambers. In some embodiments, a non-conductive sealant is injected so as to fill the entire length of single input feed port. The non-conductive sealant acts as a shunt current eliminator during battery usage in a bi-polar device.

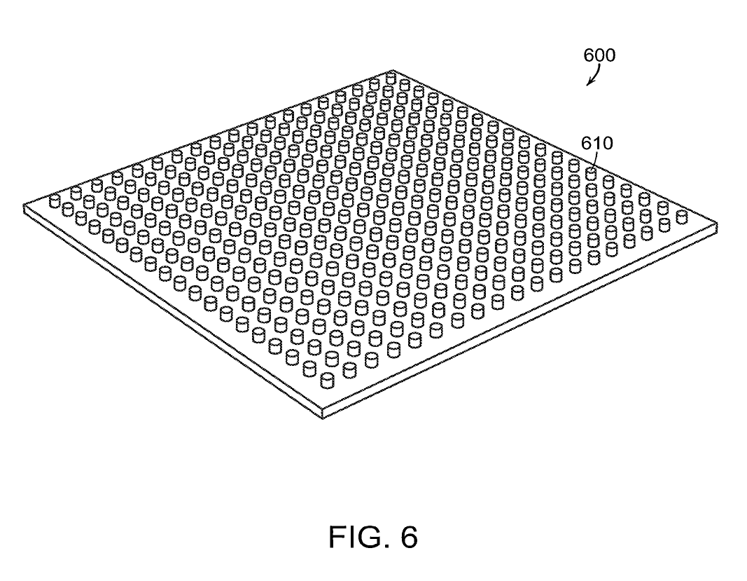

FIG. 6 shows a textured current collector. In this exemplary embodiment, conductive posts are included in the current collector. The posts increase the surface area of the collector relative to the surface area, which projected normal to the current collector. The electronic conduction path between the electrochemically active particles and the current collector are decreased by the posts. Although shown, it should be appreciated that posts 610 may not be cylindrical. For example, the posts may have polyhedral cross-section; they may be elliptical in cross-section with their semi-axes aligned so as to direct the flow of the semi-solid; the posts may be canted; the posts may have a non-constant cross section.

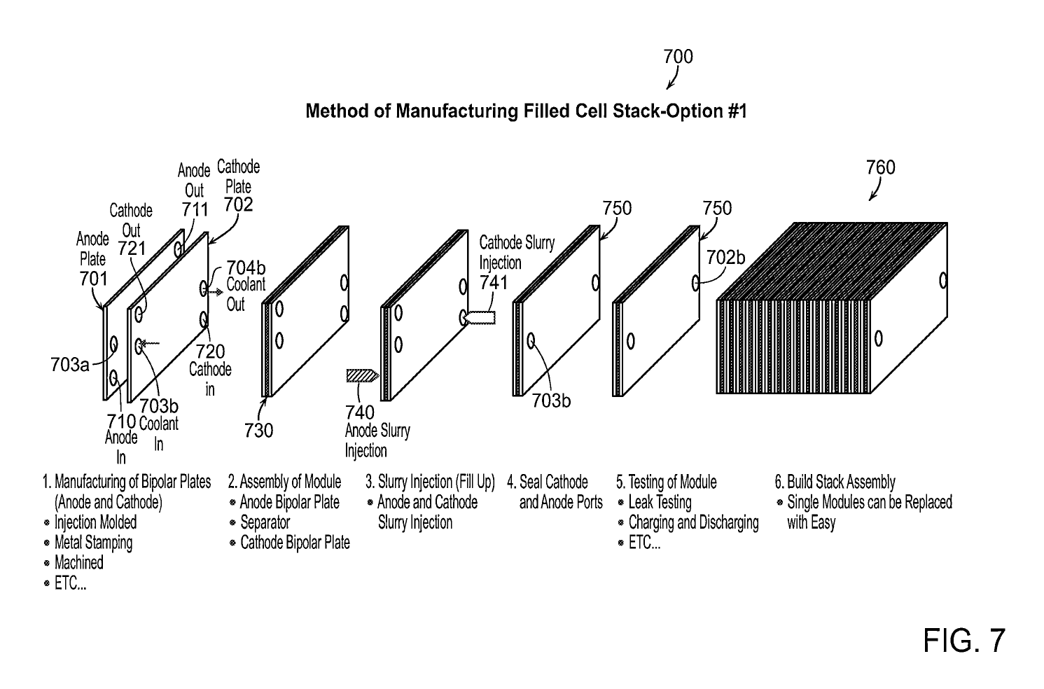

FIG. 7 demonstrates a method of manufacturing a fill multi-cell stack system. In an embodiment, single unit cells are preformed, filled, and tested before finally assembly into a stack. For example, a bipolar plate consisting of an anode plate 701 and a cathode plate 702 is shown in system 700. The anode plate has an anolyte inlet port 710 and anolyte outlet port 711. The cathode plate has a catholyte inlet port 721 and catholyte outlet port 704b. A coolant port, which is represented by 703a, 703b, and 704b is common to both plates. Another coolant outlet port, not shown, is aligned with port 704b. Additionally, each plate may contain bolt channels, which may used for subsequent steps during manufacture of the stack. For example, the plates may be manufactured by injection molding, metal stamping, or machined. Each of these plates has a container into which an anolyte and a catholyte may be injected and housed. A separator 730 is placed between the compartments on these plates and the unit cell is compressed. For each unit, an anolyte 740 and a catholyte 741 are injected into the through the appropriate ports and the unit cell is sealed (as shown in 750). This allows each unit cell to be individually tested prior to manufacture. The assembly may be serial stacked.

Alternatively, the assembly may be configured pair-wise wherein two cells are combined and assembled and tested. This configuration can be assembled into stacks of four unit cells and tested, etc. For example, electrochemical and pressure tests may be performed. A sequence of such cells can be assembled into a stack 760.

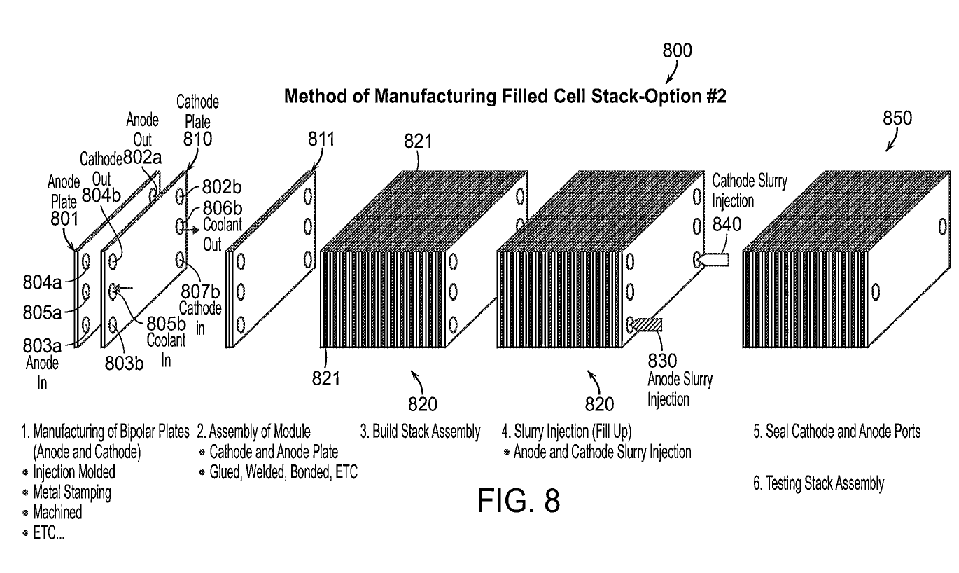

FIG. 8 is an alternative method of manufacturing a multi-cell stack. In this embodiment, single unit cells are preformed, filled, and tested before finally assembly into a stack. For example, a bipolar pair consisting of anode plate 801 and cathode plate 810 is manufactured. The anode plate has an anolyte inlet port 803a and anolyte outlet port 802a. The cathode plate has corresponding ports 803b and 802b that correspond to ports 803a and 802a, respectively. The cathode plate has a catholyte inlet port 807b and catholyte outlet port 804b. The anode plate has a corresponding port 804a that correspond to port 804b. It should be appreciated that the anode plate port that corresponds to port 807b. A coolant port, which is represented by 805a, 805b, and 806b is common to both plates. Another coolant outlet port, not shown, is aligned with port 807b. Each plate may also contain bolt channels, which may used for subsequent steps during manufacture of the stack. For example, the plates may be manufactured by injection molding, metal stamping, or machined. Each of these plates has a container into which an anolyte and a catholyte may be injected and housed. A separator 821 is placed between the compartments on these plates and the unit cell is compressed. This allows each unit cell to be individually tested prior to manufacture. The assembly may be serially stacked. Alternatively, the assembly may be configured pair-wise wherein two cells are combined and assembled and tested. For example, this configuration can be assembled into stacks of four unit cells and tested, etc. Thus, electrochemical and pressure tests may be performed. A sequence of such cells can be assembled into a stack 820. After assembly of the stack, anolyte 830 and catholyte 840 are injected into the through the appropriate ports so as to fill each individual cell (as shown in 820). As shown in 850, the stack is subsequently sealed to prevent leakage of the manufactured stack.

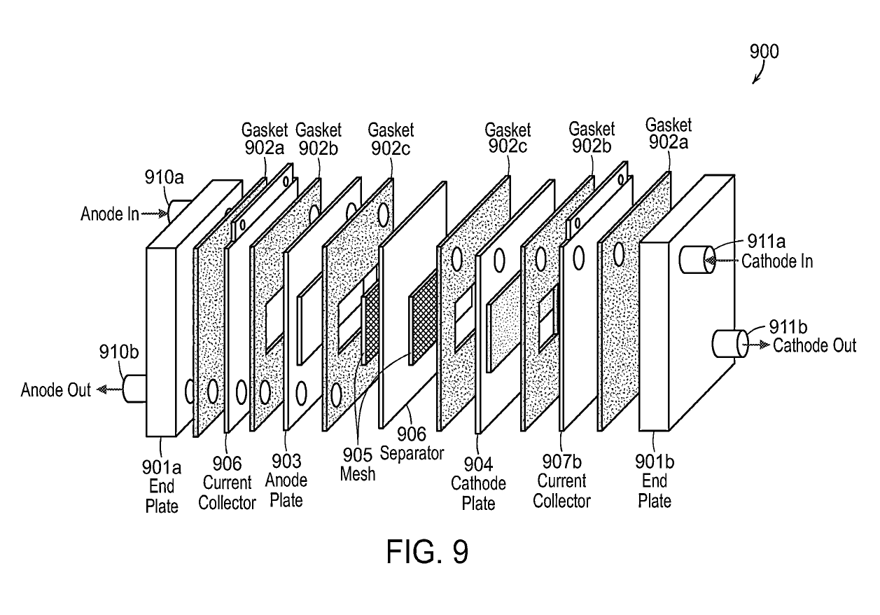

FIG. 9 is a schematic diagram of an electrochemical cell configuration according to an exemplary embodiment of the present invention. Electrochemical cell 900 consists of stainless steel end plates 901a and 901b, anode and cathode plates (903, 904), mesh 905, current collector gaskets 902b, electrode chamber gaskets 902c, anode and cathode current collectors (907a, 907b), and a microporous separator 906. The endplates are a laminate of a thin stainless steel sheet and a thicker PTFE plate. There is a thin stainless steel “shell” at the external surface to give the end plates some stiffness. The mesh can also be made of PTFE. An exemplary embodiment of the separator is a microporous separator from Tonen Chemical Corporation of Japan. The gaskets in this configuration may comprise Aflas fluoroelastomer. Each of the gaskets were made of AFLAS in the example. As shown, cell 900 was constructed in the following order: stainless steel end plate 901a, Teflon end plate, end plate gasket 902a, anode current collector 907a, current collector gasket 902b, anode plate 903, electrode chamber gasket 902c, separator 906, electrode chamber gasket 902c, cathode plate 904, current collector gasket 902b, cathode current collector 907b, end plate gasket 902a, Teflon end plate, and stainless steel end plate 901b. However, it should be appreciated that a cell may be constructed in a different order. Anode semi-solids are injected into cell 900 through inlet 910a, and removed via outlet 910b. Cathode semi-solids are injected into cell 900 through inlet 911a, and removed via outlet 911b. As shown, there are openings in each of the components that correspond with the anode and cathode inlets and outlets to allow flow of the semi-solid material throughout cell 900. The components of cell 900 are bolted together to create air tight chambers for the anode and cathode semi-solids. In an embodiment, the active area at each of the electrodes may be 3.5×3.0 cm² with the active electrode chamber volume being approximately 3.3 ml.

### Semi-Solid Composition

In one aspect, the anolyte and catholyte semi-solids provide a means to produce a substance that functions collectively as an ion-storage/ion-source, electron conductor, and ionic conductor in a single medium that acts as a working electrode.

Any anolyte and catholyte semi-solids ion-storing redox composition as described herein may have, when taken in moles per liter or molarity, at least 10M concentration of redox species, preferably at least 12M, still preferably at least 15M, and still preferably at least 20M. The electrochemically active material can be an ion storage material or any other compound or ion complex that is capable of undergoing Faradaic reaction in order to store energy. The electroactive material can also be a multiphase material including the above-described redox-active solid mixed with a non-redox-active phase, including solid-liquid suspensions, or liquid-liquid multiphase mixtures, including micelles or emulsions having a liquid ion-storage material intimately mixed with a supporting liquid phase. Systems that utilize various working ions are contemplated, including aqueous systems in which H⁺ or OH⁻ are the working ions, nonaqueous systems in which Li⁺, Na⁺, or other alkali ions are the working ions, even alkaline earth working ions such as Ca²⁺ and Mg²⁺, or Al³⁺. In each of these instances, a negative electrode storage material and a positive electrode storage material may be required, the negative electrode storing the working ion of interest at a lower absolute electrical potential than the positive electrode. The cell voltage can be determined approximately by the difference in ion-storage potentials of the two ion-storage electrode materials.

Systems employing both negative and positive ion-storage materials are particularly advantageous because there are no additional electrochemical byproducts in the cell. Both the positive and negative electrodes materials are insoluble in the flow electrolyte and the electrolyte does not become contaminated with electrochemical composition products that must be removed and regenerated. In addition, systems employing both negative and positive lithium ion-storage materials are particularly advantageous when using non-aqueous electrochemical compositions.

In some embodiments, the semi-solid ion-storing redox compositions include materials proven to work in conventional, solid lithium-ion batteries. In some embodiments, the positive semi-solid electroactive materials contains lithium positive electroactive materials and the lithium cations are shuttled between the negative electrode and positive electrode, intercalating into solid, host particles suspended in a liquid electrolyte.

In some embodiments at least one of the energy storage electrodes includes a condensed ion-storing liquid of a redox-active compound, which may be organic or inorganic, and includes but is not limited to lithium metal, sodium metal, lithium-metal alloys, gallium and indium alloys with or without dissolved lithium, molten transition metal chlorides, thionyl chloride, and the like, or redox polymers and organics that are liquid under the operating conditions of the battery. Such a liquid form may also be diluted by or mixed with another, non-redox-active liquid that is a diluent or solvent, including mixing with such a diluents to form a lower-melting liquid phase. However, unlike a conventional flow cell catholyte or anolyte, the redox active component will comprise by mass at least 10% of the total mass of the flowable electrolyte, and preferably at least 25%.

In some embodiments, the redox-active electrode material, whether used as a semi-solid or a condensed liquid format as defined above, comprises an organic redox compound that stores the working ion of interest at a potential useful for either the positive or negative electrode of a battery. Such organic redox-active storage materials include “p”-doped conductive polymers such as polyaniline or polyacetylene based materials, polynitroxide or organic radical electrodes (such as those described in: H. Nishide et al., Electrochim. Acta, 50, 827-831, (2004), and K. Nakahara, et al., Chem. Phys. Lett., 359, 351-354 (2002)), carbonyl based organics, and oxocarbons and carboxylate, including compounds such as Li₂C₆O₆, Li₂C₈H₄O₄, and Li₂C₆H₄O₄ (see for example M. Armand et al., Nature Materials, DOI: 10.1038/nmat2372) and organosulfur compounds.

In some embodiments, organic redox compounds that are electronically insulating are used. In some instance, the redox compounds are in a condensed liquid phase such as liquid or flowable polymers that are electronically insulating. In such cases, the redox active slurry may or may not contain an additional carrier liquid. Additives can be combined with the condensed phase liquid redox compound to increase electronic conductivity. In some embodiments, such electronically insulating organic redox compounds are rendered electrochemically active by mixing or blending with particulates of an electronically conductive material, such as solid inorganic conductive materials including but not limited to metals, metal carbides, metal nitrides, metal oxides, and allotropes of carbon including carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments.

In some embodiments, such electronically insulating organic redox compounds are rendered electronically active by mixing or blending with an electronically conductive polymer, including but not limited to polyaniline or polyacetylene based conductive polymers or poly(3,4-ethylenedioxythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocence-substituted polyethylene, carbazole-substituted polyethylene, polyoxyphenazine, polyacenes, or poly(heteroacenes. The conductive additives form an electrically conducting framework within the insulating liquid redox compounds that significantly increases the electrically conductivity of the composition. In some embodiments, the conductive addition forms a percolative pathway to the current collector.

In some embodiments the redox-active electrode material comprises a sol or gel, including for example metal oxide sols or gels produced by the hydrolysis of metal alkoxides, amongst other methods generally known as “sol-gel processing.” Vanadium oxide gels of composition VxOy are amongst such redox-active sol-gel materials.

Other suitable positive active materials include solid compounds known to those skilled in the art as those used in NiMH (Nickel-Metal Hydride) Nickel Cadmium (NiCd) batteries. Still other positive electrode compounds for Li storage include those used in carbon monofluoride batteries, generally referred to as CFx, or metal fluoride compounds having approximate stoichiometry MF₂ or MF₃ where M comprises Fe, Bi, Ni, Co, Ti, V. Examples include those described in H. Li, P. Balaya, and J. Maier, Li-Storage via Heterogeneous Reaction in Selected Binary Metal Fluorides and Oxides, Journal of The Electrochemical Society, 151 [11] A1878-A1885 (2004), M. Bervas, A. N. Mansour, W.-S. Woon, J. F. Al-Sharab, F. Badway, F. Cosandey, L. C. Klein, and G. G. Amatucci, “Investigation of the Lithiation and Delithiation Conversion Mechanisms in a Bismuth Fluoride Nanocomposites”, J. Electrochem. Soc., 153, A799 (2006), and I. Plitz, F. Badway, J. Al-Sharab, A. DuPasquier, F. Cosandey and G. G. Amatucci, “Structure and Electrochemistry of Carbon-Metal Fluoride Nanocomposites Fabricated by a Solid State Redox Conversion Reaction”, J. Electrochem. Soc., 152, A307 (2005).

As another example, fullerenic carbon including single-wall carbon nanotubes (SWNTs), multiwall carbon nanotubes (MWNTs), or metal or metalloid nanowires may be used as ion-storage materials. One example is the silicon nanowires used as a high energy density storage material in a report by C. K. Chan, H. Peng, G. Liu, K. Mcllwrath, X. F. Zhang, R. A. Huggins, and Y. Cui, High-performance lithium battery anodes using silicon nanowires, Nature Nanotechnology, published online 16 Dec. 2007; doi:10.1038/nnano.2007.411.

Exemplary electroactive materials for the positive electrode in a lithium system include the general family of ordered rocksalt compounds LiMO₂ including those having the α-NaFeO₂ (so-called “layered compounds”) or orthorhombic-LiMnO₂ structure type or their derivatives of different crystal symmetry, atomic ordering, or partial substitution for the metals or oxygen. M comprises at least one first-row transition metal but may include non-transition metals including but not limited to Al, Ca, Mg, or Zr. Examples of such compounds include LiCoO₂, LiCoO₂ doped with Mg, LiNiO₂, Li(Ni, Co, Al)O₂ (known as “NCA”) and Li(Ni, Mn, Co)O₂ (known as “NMC”). Other families of exemplary electroactive materials includes those of spinel structure, such as LiMn₂O₄ and its derivatives, so-called “layered-spinel nanocomposites” in which the structure includes nanoscopic regions having ordered rocksalt and spinel ordering, olivines LiMPO₄ and their derivatives, in which M comprises one or more of Mn, Fe, Co, or Ni, partially fluorinated compounds such as LiVPO₄F, other “polyanion” compounds as described below, and vanadium oxides VₓO_{y} including V₂O₅ and V₆O₁₁.

In one or more embodiments the active material comprises a transition metal polyanion compound, for example as described in U.S. Pat. No. 7,338,734. In one or more embodiments the active material comprises an alkali metal transition metal oxide or phosphate, and for example, the compound has a composition Aₓ(M′₁₋ₐM″ₐ)_{y}(XD₄)_{z}, Aₓ(M′₁₋ₐM″ₐ)_{y}(DXD₄)_{z}, or Aₓ(M′₁₋ₐM″ₐ)_{y}(X₂D₇)_{z}, and have values such that x, plus y(1−a) times a formal valence or valences of M′, plus ya times a formal valence or valence of M″, is equal to z times a formal valence of the XD₄, X₂D₇, or DXD₄ group; or a compound comprising a composition (A₁₋ₐM″ₐ)ₓM″_{y}(XD₄)_{z}, (A₁₋ₐM″ₐ)ₓM′_{y}(DXD₄)_{z}(A₁₋ₐM′ₐ)ₓM_{y}(X₂D₇)_{z} and have values such that (1−a)x plus the quantity ax times the formal valence or valences of M″ plus y times the formal valence or valences of M′ is equal to z times the formal valence of the XD₄, X₂D₇ or DXD₄ group. In the compound, A is at least one of an alkali metal and hydrogen, M′ is a first-row transition metal, X is at least one of phosphorus, sulfur, arsenic, molybdenum, and tungsten, M″ any of a Group IIA, IIIA, IVA, VA, VIA, VIIA, VIIIA, IB, IIB, IIIB, IVB, VB, and VIB metal, D is at least one of oxygen, nitrogen, carbon, or a halogen. The positive electroactive material can be an olivine structure compound LiMPO₄, where M is one or more of V, Cr, Mn, Fe, Co, and Ni, in which the compound is optionally doped at the Li, M or O-sites. Deficiencies at the Li-site are compensated by the addition of a metal or metalloid, and deficiencies at the O-site are compensated by the addition of a halogen. In some embodiments, the positive active material comprises a thermally stable, transition-metal-doped lithium transition metal phosphate having the olivine structure and having the formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In other embodiments, the lithium transition metal phosphate material has an overall composition of Li_{1-x-z}M_{1+z}PO₄, where M comprises at least one first row transition metal selected from the group consisting of Ti, V, Cr, Mn, Fe, Co and Ni, where x is from 0 to 1 and z can be positive or negative. M includes Fe, z is between about 0.15 and −0.15. The material can exhibit a solid solution over a composition range of 0<x<0.15, or the material can exhibit a stable solid solution over a composition range of x between 0 and at least about 0.05, or the material can exhibit a stable solid solution over a composition range of x between 0 and at least about 0.07 at room temperature (22-25° C.). The material may also exhibit a solid solution in the lithium-poor regime, e.g., where x≧0.8, or x≧0.9, or x≧0.95.

In some embodiments the redox-active electrode material comprises a metal salt that stores an alkali ion by undergoing a displacement or conversion reaction. Examples of such compounds include metal oxides such as CoO, Co₃O₄, NiO, CuO, MnO, typically used as a negative electrode in a lithium battery, which upon reaction with Li undergo a displacement or conversion reaction to form a mixture of Li₂O and the metal constituent in the form of a more reduced oxide or the metallic form. Other examples include metal fluorides such as CuF₂, FeF₂, FeF₃, BiF₃, CoF₂, and NiF₂, which undergo a displacement or conversion reaction to form LiF and the reduced metal constituent. Such fluorides may be used as the positive electrode in a lithium battery. In other embodiments the redox-active electrode material comprises carbon monofluoride or its derivatives. In some embodiments the material undergoing displacement or conversion reaction is in the form of particulates having on average dimensions of 100 nanometers or less. In some embodiments the material undergoing displacement or conversion reaction comprises a nanocomposite of the active material mixed with an inactive host, including but not limited to conductive and relatively ductile compounds such as carbon, or a metal, or a metal sulfide. FeS₂ and FeF₃ can also be used as cheap and electronically conductive active materials in a nonaqueous or aqueous lithium system.

In some embodiments, the working ion is selected from the group consisting of Li⁺, Na⁺, H⁺, Mg²⁺, Al³⁺, or Ca²⁺.

In some embodiments, the working ion is selected from the group consisting of Li⁺ or Na⁺.

In some embodiments, the flowable semi-solid ion-storing redox composition includes a solid including an ion storage compound.

In some embodiments, the ion is proton or hydroxyl ion and the ion storage compound includes those used in a nickel-cadmium or nickel metal hydride battery.

In some embodiments, the ion is lithium and the ion storage compound is selected from the group consisting of metal fluorides such as CuF₂, FeF₂, FeF₃, BiF₃, CoF₂, and NiF₂.

In some embodiments, the ion is lithium and the ion storage compound is selected from the group consisting of metal oxides such as CoO, Co₃O₄, NiO, CuO, MnO.

In some embodiments, the ion is lithium and the ion storage compound includes an intercalation compound selected from compounds with formula Li_{1-x-z}M_{1-z}PO₄, wherein M includes at least one first row transition metal selected from the group consisting of Ti, V, Cr, Mn, Fe, Co and Ni, wherein x is from 0 to 1 and z can be positive or negative.

In some embodiments, the ion is lithium and the ion storage compound includes an intercalation compound selected from compounds with formula (Li₁₋ₓZₓ)MPO₄, where M is one or more of V, Cr, Mn, Fe, Co, and Ni, and Z is a non-alkali metal dopant such as one or more of Ti, Zr, Nb, Al, or Mg, and x ranges from 0.005 to 0.05.

In some embodiments, the ion is lithium and the ion storage compound includes an intercalation compound selected from compounds with formula LiMPO4, where M is one or more of V, Cr, Mn, Fe, Co, and Ni, in which the compound is optionally doped at the Li, M or O-sites.

In some embodiments, the ion is lithium and the ion storage compound includes an intercalation compound selected from the group consisting of Aₓ(M′₁₋ₐM″ₐ)_{y}(XD₄)_{z}, Aₓ(M′₁₋ₐM″ₐ)_{y}(DXD₄)_{z}, and Aₓ(M′₁₋ₐM″ₐ)_{y}(X₂D₇)_{z}, wherein x, plus y(1−a) times a formal valence or valences of M′, plus ya times a formal valence or valence of M″, is equal to z times a formal valence of the XD₄, X₂D₇, or DXD₄ group; and A is at least one of an alkali metal and hydrogen, M′ is a first-row transition metal, X is at least one of phosphorus, sulfur, arsenic, molybdenum, and tungsten, M″ any of a Group IIA, IIIA, IVA, VA, VIA, VIIA, VIIIA, IB, IIB, IIIB, IVB, VB, and VIB metal, D is at least one of oxygen, nitrogen, carbon, or a halogen.

In some embodiments, the ion is lithium and the ion storage compound includes an intercalation compound selected from the group consisting of A₁₋ₐM″ₐ)ₓM′_{y}(XD₄)_{z}, (A₁₋ₐM″ₐ)ₓM′_{y}(DXD₄)z and A₁₋ₐM″ₐ)ₓM′_{y}(X₂D₇)_{z}, where (1−a)x plus the quantity ax times the formal valence or valences of M″ plus y times the formal valence or valences of M′ is equal to z times the formal valence of the XD₄, X₂D₇ or DXD₄ group, and A is at least one of an alkali metal and hydrogen, M′ is a first-row transition metal, X is at least one of phosphorus, sulfur, arsenic, molybdenum, and tungsten, M″ any of a Group IIA, IIIA, IVA, VA, VIA, VIIA, VIIIA, IB, IIB, IIIB, IVB, VB, and VIB metal, D is at least one of oxygen, nitrogen, carbon, or a halogen.

In some embodiments, the ion is lithium and the ion storage compound includes an intercalation compound selected from the group consisting of ordered rocksalt compounds LiMO₂ including those having the α-NaFeO₂ and orthorhombic-LiMnO₂ structure type or their derivatives of different crystal symmetry, atomic ordering, or partial substitution for the metals or oxygen, where M includes at least one first-row transition metal but may include non-transition metals including but not limited to Al, Ca, Mg, or Zr.

In some embodiments, the flowable semi-solid ion-storing redox composition includes a solid including amorphous carbon, disordered carbon, graphitic carbon, or a metal-coated or metal-decorated carbon.

In some embodiments, the flowable semi-solid ion-storing redox composition includes a solid including a metal or metal alloy or metalloid or metalloid alloy or silicon.

In some embodiments, the flowable semi-solid ion-storing redox composition includes a solid including nanostructures including nanowires, nanorods, and nanotetrapods.

In some embodiments, the flowable semi-solid ion-storing redox composition includes a solid including an organic redox compound.

In some embodiments, the positive electrode includes a flowable semi-solid ion-storing redox composition including a solid selected from the group consisting of ordered rocksalt compounds LiMO₂ including those having the α-NaFeO₂ and orthorhombic-LiMnO₂ structure type or their derivatives of different crystal symmetry, atomic ordering, or partial substitution for the metals or oxygen, wherein M includes at least one first-row transition metal but may include non-transition metals including but not limited to Al, Ca, Mg, or Zr and the negative electrode includes a flowable semi-solid ion-storing redox composition including a solid selected from the group consisting of amorphous carbon, disordered carbon, graphitic carbon, or a metal-coated or metal-decorated carbon.

In some embodiments, the positive electrode includes a flowable semi-solid ion-storing redox composition including a solid selected from the group consisting of Aₓ(M′₁₋ₐM″ₐ)_{y}(XD₄)_{z}, Aₓ(M′₁₋ₐM″ₐ)_{y}(DXD₄)_{z}, and Aₓ(M′₁₋ₐM″ₐ)_{y}(X₂D₇)_{z}, and where x, plus y(1−a) times a formal valence or valences of M′, plus ya times a formal valence or valence of M″, is equal to z times a formal valence of the XD₄, X₂D₇, or DXD₄ group, and A is at least one of an alkali metal and hydrogen, M′ is a first-row transition metal, X is at least one of phosphorus, sulfur, arsenic, molybdenum, and tungsten, M″ any of a Group IIA, IIIA, IVA, VA, VIA, VIIA, VIIIA, IB, IIB, IIIB, IVB, VB, and VIB metal, D is at least one of oxygen, nitrogen, carbon, or a halogen and the negative electrode includes a flowable semi-solid ion-storing redox composition including a solid selected from the group consisting of amorphous carbon, disordered carbon, graphitic carbon, or a metal-coated or metal-decorated carbon.

In some embodiments, the positive electrode includes a flowable semi-solid ion-storing redox composition including a compound with a spinel structure.

In some embodiments, the positive electrode includes a flowable semi-solid ion-storing redox composition including a compound selected from the group consisting of LiMn₂O₄ and its derivatives; layered-spinel nanocomposites in which the structure includes nanoscopic regions having ordered rocksalt and spinel ordering; so-called “high voltage spinels” with a potential vs. Li/Li+ that exceeds 4.3V including but not limited to LiNi0.5Mn1.5O4; olivines LiMPO₄ and their derivatives, in which M includes one or more of Mn, Fe, Co, or Ni, partially fluorinated compounds such as LiVPO₄F, other “polyanion” compounds, and vanadium oxides VₓO_{y} including V₂O₅ and V₆O₁₁.

In some embodiments the semi-solid flow battery is a lithium battery, and the negative electrode active compound comprises graphite, graphitic boron-carbon alloys, hard or disordered carbon, lithium titanate spinel, or a solid metal or metal alloy or metalloid or metalloid alloy that reacts with lithium to form intermetallic compounds, including the metals Sn, Bi, Zn, Ag, and Al, and the metalloids Si and Ge.

Exemplary electroactive materials for the negative electrode in the case of a lithium working ion include graphitic or non-graphitic carbon, amorphous carbon, or mesocarbon microbeads; an unlithiated metal or metal alloy, such as metals including one or more of Ag, Al, Au, B, Ga, Ge, In, Sb, Sn, Si, or Zn, or a lithiated metal or metal alloy including such compounds as LiAl, Li₉Al₄, Li₃Al, LiZn, LiAg, Li₁₀Ag₃, Li₅B₄, Li₇B₆, Li₁₂Si₇, Li₂₁Si₈, Li₁₃Si₄, Li₂₁Si₅, Li₅Sn₂, Li₁₃Sn₅, Li₇Sn₂, Li₂₂Sn₅, Li₂Sb, Li₃Sb, LiBi, or Li₃Bi, or amorphous metal alloys of lithiated or non-lithiated compositions.

In some embodiments, the negative electrode includes a semi-solid ion-storing redox composition including graphite, graphitic boron-carbon alloys, hard or disordered carbon, lithium titanate spinel, or a solid metal or metal alloy or metalloid or metalloid alloy that reacts with lithium to form intermetallic compounds, including the metals Sn, Bi, Zn, Ag, and Al, and the metalloids Si and Ge.

The current collector can be electronically conductive and should be electrochemically inactive under the operation conditions of the cell. Typical current collectors for lithium cells include copper, aluminum, or titanium for the negative current collector and aluminum for the positive current collector, in the form of sheets or mesh, or any configuration for which the current collector may be distributed in the electrolyte and permit fluid flow. Selection of current collector materials is well-known to those skilled in the art. In some embodiments, aluminum is used as the current collector for positive electrode. In some embodiments, copper is used as the current collector for negative electrode. In other embodiments, aluminum is used as the current collector for negative electrode.

In some embodiments, the negative electrode can be a conventional stationary electrode, while the positive electrode includes a semi-solid redox composition. In other embodiments, the positive electrode can be a conventional stationary electrode, while the negative electrode includes a semi-solid redox composition.

Current collector materials can be selected to be stable at the operating potentials of the positive and negative electrodes of the flow battery. In nonaqueous lithium systems the positive current collector may comprise aluminum, or aluminum coated with conductive material that does not electrochemically dissolve at operating potentials of 2.5-5V with respect to Li/Li⁺. Such materials include Pt, Au, Ni, conductive metal oxides such as vanadium oxide, and carbon. The negative current collector may comprise copper or other metals that do not form alloys or intermetallic compounds with lithium, carbon, and coatings comprising such materials on another conductor.

In some embodiments, the electrochemical function of the semi-solids redox cell is improved by mixing or blending the anode or cathode particles with particulates of an electronically conductive material, such as solid inorganic conductive materials including but not limited to metals, metal carbides, metal nitrides, metal oxides, and allotropes of carbon including carbon black, graphitic carbon, carbon fibers, carbon microfibers, vapor-grown carbon fibers (VGCF), fullerenic carbons including “buckyballs”, carbon nanotubes (CNTs), multiwall carbon nanotubes (MWNTs), single wall carbon nanotubes (SWNTs), graphene sheets or aggregates of graphene sheets, and materials comprising fullerenic fragments. In some embodiments, such electronically insulating organic redox compounds are rendered electronically active by mixing or blending with an electronically conductive polymer, including but not limited to polyaniline or polyacetylene based conductive polymers or poly(3,4-ethylenedioxythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocence-substituted polyethylene, carbazole-substituted polyethylene, polyoxyphenazine, polyacenes, or poly(heteroacenes)). In some embodiments, the resulting catholyte or anolyte mixture has an electronic conductivity of at least 10⁻⁶ S/cm, preferably at least 10⁻⁵ S/cm, more preferably at least 10⁻⁴ S/cm, and still more preferably at least 10⁻³ S/cm.

In some embodiments, the anodic or cathodic particles can be caused to have a partial or full conductive coating.

In some embodiments, the semi-solid ion-storing redox composition includes a ion-storing solid coated with a conductive coating material. In certain specific embodiments, the conductive coating material has higher electron conductivity than the solid. In certain specific embodiments, the solid is graphite and the conductive coating material is a metal, metal carbide, metal oxide, metal nitride, or carbon. In certain specific embodiments, the metal is copper.

In some embodiments, the solid of the semi-solid ion-storing material is coated with metal that is redox-inert at the operating conditions of the redox energy storage device. In some embodiments, the solid of the semi-solid ion-storing material is coated with copper to increase the conductivity of the storage material particle, to increase the net conductivity of the semi-solid, and/or to facilitate charge transfer between energy storage particles and conductive additives. In some embodiments, the storage material particle is coated with, about 1.5% by weight, metallic copper. In some embodiments, the storage material particle is coated with, about 3.0% by weight, metallic copper. In some embodiments, the storage material particle is coated with, about 8.5% by weight, metallic copper. In some embodiments, the storage material particle is coated with, about 10.0% by weight, metallic copper. In some embodiments, the storage material particle is coated with, about 15.0% by weight, metallic copper. In some embodiments, the storage material particle is coated with, about 20.0% by weight, metallic copper.

In some embodiments, the conductive coating is placed on the anodic or cathodic particles by electroplating.

In some embodiments, the conductive coating is placed on the anodic or cathodic particles by chemical precipitation of the conductive element and subsequent drying and/or calcination.

In some embodiments, the conductive coating is placed on the anodic or cathodic particles by electroplating in a fluidized bed.

In some embodiments, the conductive coating is placed on the anodic or cathodic particles by electroplating within a fluidized bed.

In some embodiments, the conductive coating is placed on the anodic or cathodic particles by co-sintering with a conductive compound and subsequent comminution.

In some embodiments, the electrochemically active particles have a continuous intraparticle conductive material or are embedded in a conductive matrix.

In some embodiments, a conductive coating and intraparticulate conductive network is produced by multicomponent-spray-drying a semi-solid of anode/cathode particles and conductive material particulates.

In some embodiments, conductive polymers are among the components semi-solid and provide a electronically conductive element. In some embodiments, the conductive polymers are one or more of: polyacetylene, polyaniline, polythiophene, polypyrrole, poly(p-phenylene), poly(triphenylene), polyazulene, polyfluorene, polynaphtalene, polyanthracene, polyfuran, polycarbazole, polyacenes, poly(heteroacenes). In some embodiments, the conductive polymer is a compound that reacts in-situ to form a conductive polymer on the surface of active materials particles. In one embodiment, the compound is 2-hexylthiophene or 3-hexylthiophene and oxidizes during charging of the battery to form a conductive polymer coating on solid particles in the cathode semi-solid suspension. In other embodiments, redox active material can be embedded in conductive matrix The redox active material can coat the exterior and interior interfaces in a flocculated or agglomerated particulate of conductive material. In other embodiments, the redox-active material and the conductive material can be two components of a composite particulate. Without being bound by any theory or mode of operation, such coatings can passivate the redox active particles and can help prevent undesirable reactions with carrier liquid or electrolyte. As such, it can serve as a synthetic solid-electrolyte interphase (SEI) layer.

In some embodiments, inexpensive iron compounds such as pyrite (FeS₂) are used as inherently electronically conductive ion storage compounds. In one embodiment, the ion that is stored is Li⁺.

In some embodiments, redox mediators are added to the semi-solid to improve the rate of charge transfer within the semi-solid electrode. In some embodiments, this redox mediator is ferrocene or a ferrocene-containing polymer. In some embodiments, the redox mediator is one or more of tetrathiafulvalene-substituted polystyrene, ferrocene-substituted polyethylene, carbazole-substituted polyethylene.

In some embodiments, the surface conductivity or charge-transfer resistance of current collectors used in the semi-solid battery is increased by coating the current collector surface with a conductive material. Such layers can also serve as a synthetic SEI layer. Non-limiting examples of conductive-coating material include carbon, a metal, metal carbide, metal nitride, metal oxide, or conductive polymer. In some embodiments, the conductive polymer includes but is not limited to polyaniline or polyacetylene based conductive polymers or poly(3,4-ethylenedioxythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocence-substituted polyethylene, carbazole-substituted polyethylene, polyoxyphenazine, polyacenes, or poly(heteroacenes). In some embodiments, the conductive polymer is a compound that reacts in-situ to form a conductive polymer on the surface of the current collector. In one embodiment, the compound is 2-hexylthiophene and oxidizes at a high potential to form a conductive polymer coating on the current collector. In some embodiments, the current collector is coated with metal that is redox-inert at the operating conditions of the redox energy storage device.

The semi-solid redox compositions can include various additives to improve the performance of the redox cell. The liquid phase of the semi-solids in such instances would comprise a solvent, in which is dissolved an electrolyte salt, and binders, thickeners, or other additives added to improve stability, reduce gas formation, improve SEI formation on the negative electrode particles, and the like. Examples of such additives include vinylene carbonate (VC), vinylethylene carbonate (VEC), fluoroethylene carbonate (FEC), or alkyl cinnamates, to provide a stable passivation layer on the anode or thin passivation layer on the oxide cathode; propane sultone (PS), propene sultone (PrS), or ethylene thiocarbonate as antigassing agents; biphenyl (BP), cyclohexylbenzene, or partially hydrogenated terphenyls, as gassing/safety/cathode polymerization agents; or lithium bis(oxatlato)borate as an anode passivation agent.

In some embodiments, the nonaqueous positive and negative electrode semi-solids redox compositions are prevented from absorbing impurity water and generating acid (such as HF in the case of LiPF₆ salt) by incorporating compounds that getter water into the active material suspension or into the storage tanks or other plumbing of the system. Optionally, the additives are basic oxides that neutralize the acid. Such compounds include but are not limited to silica gel, calcium sulfate (for example, the product known as Drierite), aluminum oxide and aluminum hydroxide.

### Example 1

### Semi-Solid Filled Cell Using Lithium Metal Oxides for Electrode Materials

### Preparation of a Non-Aqueous Lithium Titanate Spinel Anode Semi-Solid:

A suspension containing 8% by volume of lithium titanium oxide (Li₄Ti₅O₁₂) and 8% by volume carbon black as the conductive additive in 84% by volume of a nonaqueous electrolyte consisting of LiPF₆ in a mixture of alkyl carbonates was prepared by first mixing 0.7 g Li₄Ti₅O₁₂ and 0.44 g of carbon black in the dry state using a turbula mixer for 1 hr. 2.5 ml of the electrolyte was then added and the mixture was sonicated for 1 hr.

### Preparation of a Non-Aqueous Lithium Cobalt Oxide Cathode Semi-Solid:

Suspensions containing 12% by volume of lithium cobalt oxide (LiCoO₂), 8% by volume of carbon black, and the balance being an electrolyte consisting of LiPF₆ in a mixture of alkyl carbonates, were prepared. 1.05 g of lithium cobalt oxide was mixed with 0.22 g of the carbon using a turbula mixture for 1 hr. Afterwards, the electrolyte was added in the appropriate amount to make up the balance of the semi-solid suspension, and mixture was sonicated for 1 hr.

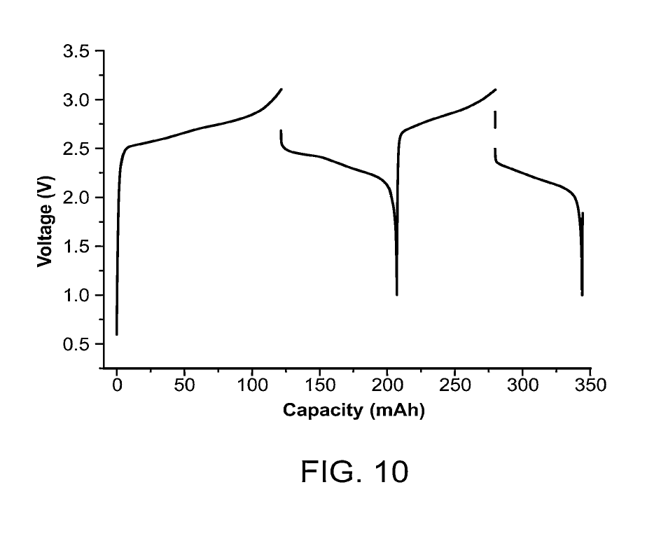

FIG. 10 shows the results of electrochemical testing performed on a cell made according to the present invention. The semi-solid semi-solids were injected into the anode and cathode chambers, respectively, of a cell of the design illustrated in FIG. 9, and the cell was sealed in an Ar-filled glovebox. The cell was galvanostatically charged and discharged between 2.7 and 3.2 V using a Solartron potentiostat operating a 1400 Cell Test System (AMETEK Inc., Paioli, Pa., USA). In FIG. 10, the cell is cycled at a current of 6.5 mA (0.62 mA/cm²) during the first cycle, corresponding to a C-rate of about C/20, and 13.3 mA (1.27 mA/cm²) during the second cycle, corresponding to a C-rate of about C/5. In the first cycle, the charge and discharge capacities are 120 and 86 mAh, respectively, giving a coulombic efficiency of 72%. In the second cycle, the charge and discharge capacities are 72 mAh and 66 mAh, respectively, giving a coulombic efficiency of 92%. In subsequent cycle at C/2 rate, the coulombic efficiency remained above 90%.

The above-described features may be implemented in combination with each other to provide various exemplary embodiments in accordance with the invention.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways within the scope and spirit of the invention.

1. A static semi-solid filled cell energy storage system comprising:
(a). a static cell stack comprising one or more static semi-solid filled cells, each cell comprising a positive electrode current collector, a negative electrode current collector, and an ion-permeable membrane separating said positive and negative current collectors, positioned and arranged to define a positive electroactive zone and a negative electroactive zone;
(b). a plurality of manifolds, wherein
i. a first manifold is configured to deliver a flowable cathode material to the positive electroactive zone first location of the static cell,
ii. a second manifold is configured to deliver flowable anode material to the a negative electroactive zone second location of the static cell; and
(c). an electronically insulating barrier housed within the first and second manifolds and configured to seal each said static cell from its neighboring static cell.

2. The static energy storage system of claim 1, further comprising at least one inlet port and outlet port configured to allow a cooling substance to circulate through the static cell to dissipate heat from the cell.

3. The static energy storage system of claim 1, further comprising at least one valve configured to allow gas to be released from the static cell, wherein cathode material is associated with the gas.

4. The static energy storage system of claim 1, further comprising at least one valve configured to allow gas to be released from the static cell, wherein the anode material is associated with the gas.

5. The static energy storage system of claim 1, wherein the cathode and anode semi-solids are configured to be reconditioned after depletion of at least a portion at least one of the cathode or anode semi-solids.

6. The static energy storage system of claim 1, wherein the electronically insulating barrier is threaded such that they can be inserted and removed from the manifolds.

7. The static energy storage system of claim 1, further comprising a device configured to add a salt suspension to the electrode material housed in the first and second location of the static cell.

8. The static energy storage system of claim 7, wherein at least one of the cathode material and the anode material comprises ion storage compound particles having a polydisperse size distribution in which the finest particles present in at least 5 vol % of the total volume, is at least a factor of 5 smaller than the largest particles present in at least 5 vol % of the total volume.

9. The static energy storage system of claim 1, wherein at least one of the cathode material and the anode material comprises an electrically conductive additive.

10. The static energy storage system of claim 1, wherein at least one of the cathode material and the anode material further comprises a redox mediator.

11. The static energy storage system of claim 1, wherein at least one of the cathode and anode materials include particles with a diameter of at least 1 micrometer.

12. The static energy storage system of claim 1, wherein at least one of the cathode and anode material include particles of at least 10 micrometers.

13. The static energy storage system of claim 1, wherein the plurality of manifolds are removable.

14. A method of manufacturing a static cell energy storage system comprising:
(a). providing a static cell, wherein the static cell has a first subassembly for housing a cathode semi-solid and a second subassembly for housing an anode semi-solid;
(b). connecting the static cell to a first manifold configured to deliver the cathode semi-solid to the first subassembly;
(c). connecting the static cell to a second manifold configured to deliver the anode semi-solid to the second subassembly;
(d). transferring cathode and anode semi-solids from a location external to the static cell to the first and second subassemblies through the first and second manifolds;
(e). inserting an electronically insulating member into the inlet and outlet of the first manifold to thereby isolate each first subassembly; and
(f). inserting an electronically insulating member into the inlet and outlet of the second manifold to thereby isolate each second subassembly.

15. The method of claim 14, wherein the first and second locations of the static cell are preconfigured to comprise a powdered substance.

16. The method of claim 14, wherein the temperature of the first and second locations are increased prior to the addition of cathode or anode material.

17. The method of claim 14, wherein at least one of the cathode material and anode material are introduced into the respective subassembly in a first chemical state and converting the at least one of the cathode material and anode material into second chemical state in the respective subassembly, said first state have a lower viscosity than the second state.

18. The method of claim 17, wherein the chemical state of the at least one of the cathode material and anode material is chemically converted by adding a salt to the respective subassembly after introduction of the cathode and anode material.

19. The method of claim 14, wherein at least one of the cathode material and the anode material is introduced into the respective subassembly as a powdered substance.

20. The method of claim 19, further comprising adding an electrolyte into the respective subassembly after introduction of the powdered substance.

21. The method of claim 14, further comprising increasing the temperature of the first and second subassemblies prior to the cathode or anode semi-solids entering the first and second manifold.

22. The method of claim 14, wherein at least one of the cathode and anode material is introduced as a foam.

23. A method of manufacturing a static cell energy storage system comprising:
(a). providing a static cell, wherein the static cell has a first subassembly for housing a cathode semi-solid and a second subassembly for housing an anode semi-solid; wherein the first subassembly comprises one or more first openings for receiving the cathode semi-solid and the second subassembly comprises one or more second openings for receiving the anode semi-solid;
(b). connecting the static cell to a first manifold configured to deliver the cathode semi-solid to the first subassembly;
(c). connecting the static cell to a second manifold configured to deliver the anode semi-solid to the second subassembly;
(d). transferring cathode and anode semi-solids to the first and second subassemblies through the first and second manifolds; and
(e). removing the first and second manifolds and sealing the first and second openings.
